(19) United States
(12) Patent Application Publication
(10) Pub. No.: US 2024/0280664 A1
(43) Pub. Date: Aug. 22, 2024

(54) HOPPING PATTERN UTILIZATION FOR MULTI-RADAR COEXISTENCE

(71) Applicant: QUALCOMM Incorporated, San Diego, CA (US)

(72) Inventors: Stelios STEFANATOS, San Diego, CA (US); Junyi LI, Fairless Hills, PA (US); Kapil GULATI, Belle Mead, NJ (US)

(21) Appl. No.: 18/569,944

(22) PCT Filed: Jul. 27, 2022
(86) PCT No.: PCT/US2022/038468

§ 371 Date: Dec. 13, 2023

(30) Foreign Application Priority Data
Aug. 24, 2021 (GR) 20210100569

(51) Int. Cl. G01S 7/02; G01S 13/931

(52) U.S. Cl. CPC G01S 7/0234; G01S 13/931; G01S 2013/9316

(57) ABSTRACT

Methods, systems, and devices for wireless communications are described. Each user equipment (UE) in a vehicle-to-everything (V2X) system may select a hopping pattern for transmitting a set of radar signals. A victim UE may experience interference from an interfering UE. The victim UE may receive a set of radar signals in a set of transmission frames from the interfering UE. The victim UE may detect a hopping pattern from the set of radar signals based on receiving the set of radar signals in the set of transmission frames. The victim UE may transmit a sidelink message to an interfering UE for interference coordination based on detecting the hopping pattern.

### CROSS REFERENCE

The present application is a 371 national stage filing of International PCT Application No. PCT/US2022/038468 by STEFANATOS et al. entitled “HOPPING PATTERN UTILIZATION FOR MULTI-RADAR COEXISTENCE,” filed Jul. 22, 2022; and claims priority to Greece patent application 20210100569 by STEFANATOS et al., entitled “HOPPING PATTERN UTILIZATION FOR MULTI-RADAR COEXISTENCE,” filed Aug. 24, 2021, each of which is assigned to the assignee hereof, and each of which is expressly incorporated by reference in its entirety herein.

### FIELD OF TECHNOLOGY

The following relates to wireless communications, including hopping pattern utilization for multi-radar coexistence.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

### SUMMARY

The described techniques relate to improved methods, systems, devices, and apparatuses that support hopping pattern utilization for multi-radar coexistence. Generally, the described techniques provide for a user equipment (UE) to detect a hopping pattern of a set of radar signals from another UE and to perform interference coordination with the other UE. For example, a UE in a vehicle-to-everything (V2X) system may select a hopping pattern for transmitting a set of radar signals and a victim UE may be referred to as a UE that experiences interference from another UE (e.g., an interfering UE). The victim UE may receive a set of radar signals in a set of transmission frames from the interfering UE. The victim UE may detect a hopping pattern from the set of radar signals based on receiving the set of radar signals in the set of transmission frames. The victim UE may transmit a sidelink message to an interfering UE for interference coordination based on detecting the hopping pattern.

A method for wireless communication at a first UE is described. The method may include receiving a set of radar signals in a set of transmission frames, detecting a hopping pattern associated with the set of radar signals based on receiving the set of radar signals in the set of transmission frames, and transmitting, to a second UE, a sidelink message for interference coordination between the first UE and the second UE based on detecting the hopping pattern.

An apparatus for wireless communication at a first UE is described. The apparatus may include a processor, memory coupled with the processor, and instructions stored in the memory. The instructions may be executable by the processor to cause the apparatus to receive a set of radar signals in a set of transmission frames, detect a hopping pattern associated with the set of radar signals based on receiving the set of radar signals in the set of transmission frames, and transmit, to a second UE, a sidelink message for interference coordination between the first UE and the second UE based on detecting the hopping pattern.

Another apparatus for wireless communication at a first UE is described. The apparatus may include means for receiving a set of radar signals in a set of transmission frames, means for detecting a hopping pattern associated with the set of radar signals based on receiving the set of radar signals in the set of transmission frames, and means for transmitting, to a second UE, a sidelink message for interference coordination between the first UE and the second UE based on detecting the hopping pattern.

A non-transitory computer-readable medium storing code for wireless communication at a first UE is described. The code may include instructions executable by a processor to receive a set of radar signals in a set of transmission frames, detect a hopping pattern associated with the set of radar signals based on receiving the set of radar signals in the set of transmission frames, and transmit, to a second UE, a sidelink message for interference coordination between the first UE and the second UE based on detecting the hopping pattern.

In some examples of the method, apparatuses, and non-transitory computer-readable medium described herein, detecting the hopping pattern may include operations, features, means, or instructions for detecting a variation in a frame start time of the set of radar signals in the set of transmission frames or a variation in frame phase ramp of the set of radar signals in the set of transmission frames, or both, where the hopping pattern may be associated with a finite duration.

Some examples of the method, apparatuses, and non-transitory computer-readable medium described herein may further include operations, features, means, or instructions for determining that the second UE may be associated with the detected hopping pattern based on a periodicity of the hopping pattern.

In some examples of the method, apparatuses, and non-transitory computer-readable medium described herein, determining that the second UE may be associated with the detected hopping pattern may include operations, features, means, or instructions for determining a UE identifier (ID) associated with the hopping pattern based on a codebook for hopping patterns.

Some examples of the method, apparatuses, and non-transitory computer-readable medium described herein may further include operations, features, means, or instructions for applying a decoder to the detected hopping pattern to obtain the UE ID.

In some examples of the method, apparatuses, and non-transitory computer-readable medium described herein, transmitting the sidelink message may include operations, features, means, or instructions for transmitting the sidelink message to a set of multiple UEs in a broadcast or groupcast transmission, the set of multiple UEs including the second UE.

Some examples of the method, apparatuses, and non-transitory computer-readable medium described herein may further include operations, features, means, or instructions for receiving sidelink control information indicating a zone ID of the second UE and determining a position of the second UE relative to the first UE based on the zone ID, where transmitting the sidelink message may be based on the position of the second UE.

In some examples of the method, apparatuses, and non-transitory computer-readable medium described herein, the sidelink message includes an indication of the detected hopping pattern, an additional hopping pattern associated with the first UE, or both.

A method for wireless communication at a vehicle UE is described. The method may include selecting a first hopping pattern for transmitting radar signaling by the vehicle UE, the first hopping pattern indicative of an identity of the vehicle UE and associated with a hopping pattern periodicity and transmitting a set of radar signals in a set of transmission frames according to the first hopping pattern and the hopping pattern periodicity.

An apparatus for wireless communication at a vehicle UE is described. The apparatus may include a processor, memory coupled with the processor, and instructions stored in the memory. The instructions may be executable by the processor to cause the apparatus to select a first hopping pattern for transmitting radar signaling by the vehicle UE, the first hopping pattern indicative of an identity of the vehicle UE and associated with a hopping pattern periodicity and transmit a set of radar signals in a set of transmission frames according to the first hopping pattern and the hopping pattern periodicity.

Another apparatus for wireless communication at a vehicle UE is described. The apparatus may include means for selecting a first hopping pattern for transmitting radar signaling by the vehicle UE, the first hopping pattern indicative of an identity of the vehicle UE and associated with a hopping pattern periodicity and means for transmitting a set of radar signals in a set of transmission frames according to the first hopping pattern and the hopping pattern periodicity.

A non-transitory computer-readable medium storing code for wireless communication at a vehicle UE is described. The code may include instructions executable by a processor to select a first hopping pattern for transmitting radar signaling by the vehicle UE, the first hopping pattern indicative of an identity of the vehicle UE and associated with a hopping pattern periodicity and transmit a set of radar signals in a set of transmission frames according to the first hopping pattern and the hopping pattern periodicity.

In some examples of the method, apparatuses, and non-transitory computer-readable medium described herein, selecting the first hopping pattern may include operations, features, means, or instructions for randomly selecting the first hopping pattern from a set of hopping patterns available for radar signaling by the vehicle UE.

In some examples of the method, apparatuses, and non-transitory computer-readable medium described herein, selecting the first hopping pattern may include operations, features, means, or instructions for selecting the first hopping pattern from a set of hopping patterns configured for radar signaling by the vehicle UE.

In some examples of the method, apparatuses, and non-transitory computer-readable medium described herein, selecting the first hopping pattern may include operations, features, means, or instructions for selecting the first hopping pattern from a codebook based on a UE ID corresponding to the vehicle UE, the codebook including a set of multiple hopping patterns for radar signaling.

In some examples of the method, apparatuses, and non-transitory computer-readable medium described herein, the first hopping pattern may be uniquely mapped to the UE ID, and the codebook includes a system-wide codebook.

In some examples of the method, apparatuses, and non-transitory computer-readable medium described herein, the codebook includes a hopping pattern list including the first hopping pattern, and the UE ID includes a UE group ID corresponding to the first hopping pattern.

In some examples of the method, apparatuses, and non-transitory computer-readable medium described herein, selecting the first hopping pattern may include operations, features, means, or instructions for generating the first hopping pattern based on performing an encoding operation on a binary alphabet representation of one or more parameter values corresponding to the vehicle UE, where the first hopping pattern may be unique to a UE ID corresponding to the vehicle UE.

In some examples of the method, apparatuses, and non-transitory computer-readable medium described herein, the one or more parameters include the UE ID, orientation of the radar signaling, a transmit power, or a combination thereof.

Some examples of the method, apparatuses, and non-transitory computer-readable medium described herein may further include operations, features, means, or instructions for receiving, from a second UE, a sidelink message indicating a second hopping pattern, a third hopping pattern corresponding to the second UE, or both, determining at least one of the second hopping pattern or the third hopping pattern satisfies a threshold associated with the first hopping pattern, and performing interference coordination with the second UE based on determining that the at least one of the second hopping pattern or the third hopping pattern satisfying the threshold.

In some examples of the method, apparatuses, and non-transitory computer-readable medium described herein, the threshold may be configured at the vehicle UE.

In some examples of the method, apparatuses, and non-transitory computer-readable medium described herein, the threshold includes a first value for the second hopping pattern and a second value for the third hopping pattern.

In some examples of the method, apparatuses, and non-transitory computer-readable medium described herein, determining that the second hopping pattern satisfies the threshold may include operations, features, means, or instructions for determining a correlation product of the second hopping pattern and the first hopping pattern and comparing the correlation product with the threshold.

Some examples of the method, apparatuses, and non-transitory computer-readable medium described herein may further include operations, features, means, or instructions for establishing a unicast connection with an additional UE based on the transmitted set of radar signals, the unicast connection for performing interference coordination between the vehicle UE and the additional UE.

Some examples of the method, apparatuses, and non-transitory computer-readable medium described herein may further include operations, features, means, or instructions for receiving a second set of radar signals in a second set of transmission frames, detecting a second hopping pattern associated with the second set of radar signals based on receiving the second set of radar signals in the second set of transmission frames, and transmitting, to a second UE, a sidelink message for interference coordination between the vehicle UE and the second UE based on detecting the second hopping pattern.

Some examples of the method, apparatuses, and non-transitory computer-readable medium described herein may further include operations, features, means, or instructions for determining a correlation between the second hopping pattern and the first hopping pattern, where transmitting the sidelink message may be based on the correlation satisfying a threshold.

### BRIEF DESCRIPTION OF THE DRAWINGS

FIGS. 1 through 3 illustrate examples of wireless communications systems that support hopping pattern utilization for multi-radar coexistence in accordance with aspects of the present disclosure.

FIG. 4 illustrates an example of a process flow that supports hopping pattern utilization for multi-radar coexistence in accordance with aspects of the present disclosure.

FIGS. 5 and 6 show block diagrams of devices that support hopping pattern utilization for multi-radar coexistence in accordance with aspects of the present disclosure.

FIG. 7 shows a block diagram of a communications manager that supports hopping pattern utilization for multi-radar coexistence in accordance with aspects of the present disclosure.

FIG. 8 shows a diagram of a system including a device that supports hopping pattern utilization for multi-radar coexistence in accordance with aspects of the present disclosure.

FIGS. 9 through 13 show flowcharts illustrating methods that support hopping pattern utilization for multi-radar coexistence in accordance with aspects of the present disclosure.

### DETAILED DESCRIPTION

In some wireless communications systems, such as a vehicle to everything (V2X) system, there may be a high density of wireless devices, such as multiple vehicle user equipments (UEs), which may be equipped with radar systems. A wireless device, such as a vehicle UE, may include multiple radar components, such as radar transceivers, capable of transmitting and receiving radar signaling. Communications to and from the wireless devices may interfere with each other. In some cases, vehicle UEs may transmit radar signals at the same time or with a same frequency, which may cause interference between such UEs. The interference may increase the noise level at a victim vehicle UE, which may result in a ghost target being identified by the victim vehicle UE or may mask an actual target detection. For example, one or more UEs transmitting interfering radar signals may result in targets that may not be differentiable from an actual target or may interfere with an actual target. In such cases, even if the victim UE is aware of the interference, the victim vehicle UE may be unable to identify which neighboring UE is causing the interference and may therefore be unable to perform interference mitigation or other interference coordination techniques.

In some examples, a V2X system may support hopping patterns that may be associated with each vehicle UE (e.g., each vehicle UE may have a specific or unique hopping pattern). For example, a vehicle UE may select a hopping pattern for transmitting radar signaling according to a start time of transmission frames, a frame phase ramp across the transmission frames, a periodicity, or any combination thereof. The vehicle UE may transmit radar signaling in the transmission frames according to the hopping pattern. In some cases, the vehicle UE may be close enough in distance to another vehicle UE, which may be referred to as a victim UE, such that the radar signaling may overlap (e.g., in time, frequency, or both) with radar signaling from the victim UE, which may cause interference at the victim UE. In some cases, the victim UE may detect the hopping pattern based on the radar signaling and may attempt to coordinate interference mitigation. For example, the victim UE may identify a UE identifier of the aggressor or interfering UE. The victim UE may transmit a sidelink message for interference coordination to the aggressor UE.

Aspects of the disclosure are initially described in the context of wireless communications systems. Aspects of the disclosure are then described in the context of a process flow. Aspects of the disclosure are further illustrated by and described with reference to apparatus diagrams, system diagrams, and flowcharts that relate to hopping pattern utilization for multi-radar coexistence.

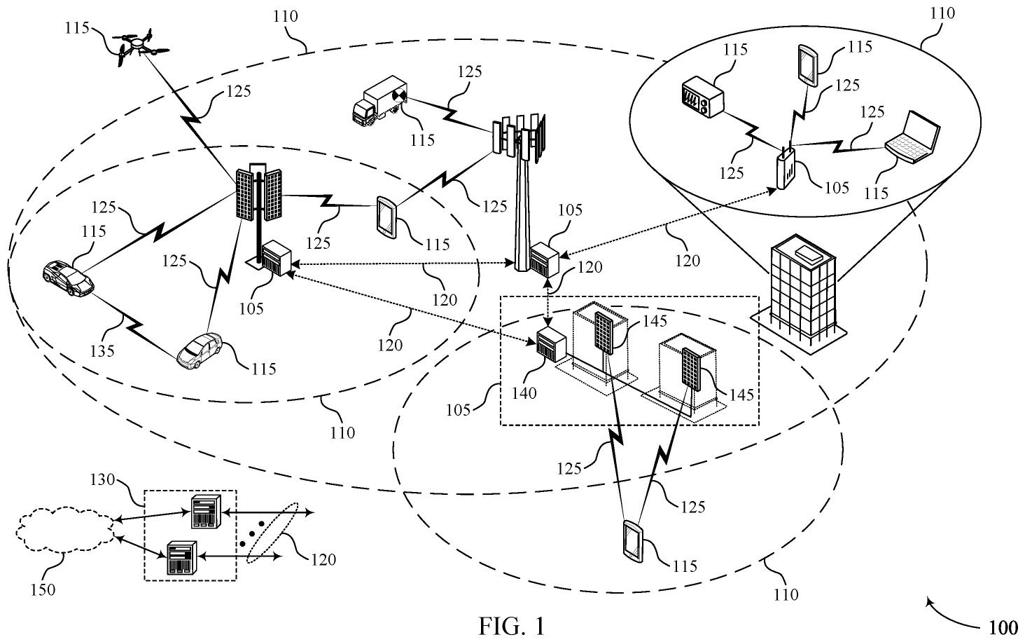

FIG. 1 illustrates an example of a wireless communications system 100 that supports hopping pattern utilization for multi-radar coexistence in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In some cases, Frequency Modulated Continuous Wave (FMCW) or Phase Modulated Continuous Wave (PMCW) parameters and hopping patterns for transmission frame start time, phase ramp, or both may be enhanced by associating the hopping pattern with an ID (e.g., a UE ID) of a UE 115. A victim UE 115 may perform a pattern identification, which may effectively identify an interferer UE 115. The victim UE may, in turn, communicate with the interferer UE 115 to adjust transmissions to reduce or avoid interference. UEs 115 may select a hopping pattern, and associate the hopping pattern with a UE ID. The victim UE 115 may identify the interferer from an identified or detected hopping pattern. The victim UE 115 and the interferer UE 115 may leverage sidelink (e.g., mode 2 sidelink) for assigning UE IDs to radar components of each UE 115 (e.g., set the same as sidelink UE IDs) and exchanging messages to identifying pairs of interferers, such as mutual interferers. Thus, pairs of UEs 115 that happen to select same or similar hopping patterns may also be capable of reducing or mitigating interference.

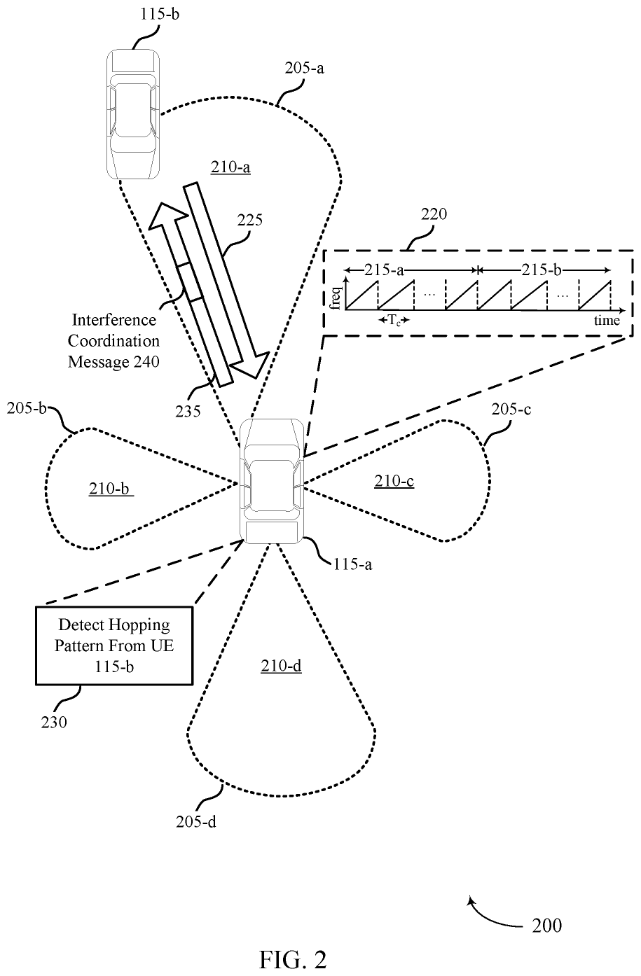

FIG. 2 illustrates an example of a wireless communications system 200 that supports hopping pattern utilization for multi-radar coexistence in accordance with aspects of the present disclosure. In some examples, the wireless communications system 200 may implement aspects of the wireless communications system 100. For example, the wireless communications system 200 includes UE 115-a and UE 115-b, which may be examples of a UE 115 as described with reference to FIG. 1. In some examples, UE 115-a may detect a hopping pattern of a set of radar signals from UE 115-b and may perform interference coordination with UE 115-b.

In some cases, a UE 115 may transmit radar signaling 205 within a field of view (FOV) 210 of the UE 115. For example, UE 115-a may transmit radar signaling 205-a, radar signaling 205-b, radar signaling 205-c, and radar signaling 205-d each from a respective radar component of UE 115-a. The radar signaling 205 may be FMCW signaling or PMCW signaling, which may support various functionalities, including, for example, target ranging, environmental and object detection, and target tracking among other examples. In some cases, the radar signaling 205 may include a number of “chirps” (e.g., periodic FMCWs sweeping in frequency over a defined frequency range) over multiple transmission frames 215, according to resource diagram 220. Each chirp may be associated with a number of transmission parameters including a slope, a start frequency, a time offset, a chirp duration or period (represented by Tc), a frequency offset, a number of frequency chirps within a transmission frame 215, or any combination thereof.

If a target reflects the chirps, the first radar component at the UE 115-a may receive the reflected chirps (e.g., the reflected FMCW waveform) after a delay (e.g., a propagation delay, t). UE 115-a may use signal processing to calculate the target range, the velocity of the target (e.g., by observing a linear rate by which the phase increases per chirp within a transmission frame 215), and the like over multiple back-to-back transmission frames 215, such as transmission frame 215-a and transmission frame 215-b. Each transmission frame 215 may have a number of range-velocity detections for the time the transmission frame 215 is transmitted, such as one for each target present in a field (e.g., FOV 210). A UE 115 may combine successive transmission frame detection results in a time series of detections that may be input to a data-association and track-detection filter. The filter may jointly process the detections across transmission frames 215 and group detections originating from a same target towards creating target “tracks” (e.g., trajectories).

The fundamental element of an FMCW waveform is the chirp, which can be mathematically represented according to Equation 1:

$$x ( t ) = c \times {e}^{i 2 π {f}_{c} t} {e}^{i π ( \frac{B}{{T}_{up}} ) {t}^{2}} , \qquad ( 1 )$$

$$0 \leq t \leq {T}_{up} ,$$

where f is a carrier frequency (e.g., 77 GHZ), B is a chirp bandwidth (e.g., 1 GHZ), Tᵤₚ is an “upchirp” duration (e.g., where the chirp instantaneous frequency increases linearly from f_{c} to f_{c}+B), and c is a constant complex scalar that captures aspects like phase-locked loop (PLL) phase. In some case, FMCW radar processing may operate on a sequence of chirps in a transmission frame 215, each including a number of chirps, N_{c}. A waveform for transmission frame 215-a or transmission frame 215-b, as illustrated in resource diagram 220, may be represented as Σ_{m=0, . . . , N}_{_{c}}₋₁ xₘ(t), 0≤t≤N_{c}T_{c}, where xₘ(t):=x(t−mT_{c}) is the m-th chirp within the frame and T_{c}≥Tᵤₚ may be the chirp transmission period.

A frame transmitted at t=0 may reflect to a target (e.g., if one exists) and return back with a delay τ>0. If the radar and target have a zero relative velocity (e.g., both are stationary), this delay equals

$$τ = \frac{2 d}{{c}_{0}} ,$$

where d is the distance or range of the target from the radar and c₀ is the speed of light. Thus, the delay of the received chirps relative to the transmitted chirps may be proportional to the range (e.g., the distance from the first radar component to the target), where the range may be calculated as C₀τ/2. With a non-zero relative velocity, v, the delay may be time-varying (e.g., each chirp in a transmission frame 215 may experience a different delay with respect to the time the chirp was transmitted), depending on the distance the target was when the chirp “hit” the target. For some speeds, the delay that the m-th chirp experiences may be determined using

$${τ}_{m} = \frac{2 ( d + {vmT}_{c} )}{{c}_{0}} ,$$

where d now represents the distance of the target when the first chirp is reflected. The m-th chirp may be received at the radar as yₘ(t):=h×xₘ(t−τₘ), where h represents the propagation losses and channel attenuation, assumed constant throughout the frame duration. The received waveform may be mixed with the transmitted waveform and the output for the m-th chirp duration may be approximately calculated according to Equation 2:

$${z}_{m} ( t ) := {x}_{m}^{*} ( t ) {y}_{m} ( t ) \approx h \times {e}^{- i 2 π {f}_{c} ( \frac{2 {T}_{c} v}{{c}_{0}} ) m} {e}^{- i 2 π ( \frac{B}{{T}_{up}} ) ( \frac{2 d}{{c}_{0}} ) t} , \qquad ( 2 )$$

where, h may be a constant that incorporates factors that may not depend on either m or t, such that

$$h = h \times {e}^{- i 2 π {f}_{c} ( \frac{2 d}{{c}_{0}} )} .$$

In some cases, a mixer output signal may be filtered (e.g., to remove broadband noise) and then sampled with a sampling frequency of Tₛ, which may result in a 2 dimensional (2D) discrete-time signal according to Equation 3:

$${z}_{m} [ n ] := {z}_{m} ( {nT}_{s} ) = h \times {e}^{- i 2 π {f}_{c} ( \frac{2 {T}_{c} v}{{c}_{0}} ) m} {e}^{- i 2 π ( \frac{B}{{T}_{up}} ) ( \frac{2 d}{{c}_{0}} ) {T}_{s} n} , \qquad ( 3 )$$

$$0 \leq m \leq {N}_{c} - 1 ,$$

$$0 \leq n \leq N - 1 ,$$

where

$$N \leq \frac{{T}_{up}}{{T}_{s}}$$

is the number of samples within the upchirp interval the receiver considers per chirp. The sampled signal may be a 2D complex exponential (e.g., a harmonic signal) with a 2D frequency

$$( {f}_{c} ( \frac{2 {T}_{c} v}{{c}_{0}} ) , ( \frac{B}{{T}_{up}} ) ( \frac{2 d}{{c}_{0}} ) {T}_{s} )$$

with parameters d and v “encoded” in the frequency. Thus, the identification of the 2D harmonic signal may provide the target range and velocity. Estimation of the 2D frequency may be obtained via a 2D fast Fourier transform (FFT) of size Ñ_{c}≥N_{c} over the “m” dimension and size Ñ≥N over the “n” dimension. Let

$$( {m}^{*} , {n}^{*} ) ∈ [ 0 , … , {\tilde{N}}_{c} - 1 ] \times [ - \frac{\tilde{N}}{2} - 1 , … , \frac{\tilde{N}}{2} - 1 ]$$

denote the “bin” index of the 2D FFT with a maximum power. The range of the target may be estimated as

$$\hat{d} = - \frac{{n}^{*} {cT}_{up}}{{\tilde{N}}_{c} 2 {BT}_{s}}$$

and the velocity as

$$\hat{v} = - \frac{{m}^{*} c}{2 {f}_{c} {T}_{c}} .$$

When multiple, targets, K>1, are present, the 2D signal zₘ [n] may include K harmonics, that may be identified via a single 2D-FFT and the range-velocity of each target may be identified according to the above estimations for each harmonic.

In some examples, the radar receiver may use a filter, 2D FFT processing, and an association tracking filter when detecting a target. The association tracking filter may process the time series of detections identified per transmission frame 215. The association tracking filter may examine the attributes of the detections (e.g., range and velocity) and may group detections in successive frame as originating from a same target. In some cases, multiple targets, or tracks, may be detected. The association tracking filter may identify new tracks (e.g., corresponding to new detections with attributes not matching current tracks) and discard tracks (e.g., due to detections with the track attributes are no longer identified). The association tracking filter may discard detections without associating them to a track when their attributes suggest they are noise artifacts.

A first radar component of UE 115-a may transmit radar signaling 205-a in FOV 210-a of the first radar component. In some examples, the first radar component may be located, for example, on a side or roof of UE 115-a and may support radar ranging and detection within FOV 210-a. The first radar component may, in some cases, receive reflected radar signaling from a target, which may be an example of a vehicle UE (e.g., UE 115-b) or other target object such as a pedestrian, bicycle, road side unit (RSU), or the like. The first radar component may detect the target based on the reflected radar signaling and may track the target as the target moves through or within the FOV 210-a of the first radar component (e.g., according to the process as described above). While UE 115-a is depicted as transmitting radar signaling 205-a, radar signaling 205-b, radar signaling 205-c, and radar signaling 205-d from a number of radar components respectively, it is to be understood that such an example is not intended to be limiting and UE 115-a may include any number of radar components for transmitting radar signaling 205. Each additional radar component may also detect and track targets based on reflected radar signaling within respective FOVs 210.

In some cases, the density of radar-equipped (e.g., FMCW radar-equipped) vehicle UEs 115 in wireless communication system 200 may be such that multi-radar interference may occur. In scenarios where multiple radar-equipped UEs 115 operate over a same frequency, a signal transmitted from a UE 115 may be received by a nearby UE 115, causing interference 225. For example, UE 115-b may transmit radar signaling 205, which may result in interference 225 at UE 115-a, which may be referred to as a victim UE 115. For example, UE 115-a may receive one or more radar signals from UE 115-b, such as a set of radar signals. UE 115-b may send the set of radar signals in a set of transmission frames, where each transmission frame, T_{c}, spans a duration. The radar signaling 205 from UE 115-b may interfere with radar signaling 205-a if UE 115-b is in FOV 210-a, radar signaling 205-b if UE 115-b is in FOV 210-b, radar signaling 205-c if UE 115-b is in FOV 210-c, radar signaling 205-d if UE 115-b is in FOV 210-d, or a combination thereof. The interference 225 may increase the noise level at victim vehicle UE 115-a, which may result in a ghost target being identified by victim vehicle UE 115-a or may mask an actual target detection. For example, one or more UEs 115 transmitting interfering radar signals (e.g., UE 115-b) may result in targets that may not be differentiable from an actual target or may interfere with an actual target and even if the victim UE 115-a is aware of the interference 225, the victim vehicle UE 115-a may be unable to identify which neighboring UE 115 is causing the interference 225 to perform interference mitigation.

In some examples, the victim vehicle UE 115-a may perform signal processing involving discarding observed samples contaminated by the interference 225 or identifying the portion of the received energy due to the interference 225 and canceling the portion out (e.g., interference cancelation). However, in conditions with relatively high occurrence of interference 225 (e.g., with many radar-equipped UEs 115), the sample-discarding approach may not work due to the high number of samples being discarded and the relatively high computational power and time used to perform the signal processing. Further, an interference mitigation method where ghost targets generated by the interference 225 appear as unrealistically hopping in range, velocity, or both and are therefore discarded by the radar receive filter may rely on the interfering radar components selecting different hopping patterns.

For a relatively low number of radar components in the wireless communications system 200, the radar components may coordinate to avoid interfering with each other (e.g., using a TDM scheme, FDM scheme, reduced transmit power, or the like). In some cases, the signals transmitted by each radar component may be the same. The transmissions may overlap in time and frequency. That is, the coordination may be with respect to the signal (e.g., waveform) being the same for each radar component. The UEs 115 in wireless communications system 200 may employ similar FMCW parameters (e.g., bandwidth, chirp duration, frame duration, and the like). A victim vehicle UE 115-a may be unable to identify an interfering UE 115, since the victim vehicle UE 115-a may be unable to differentiate between the ghost target detections and actual targets in a single transmission frame.

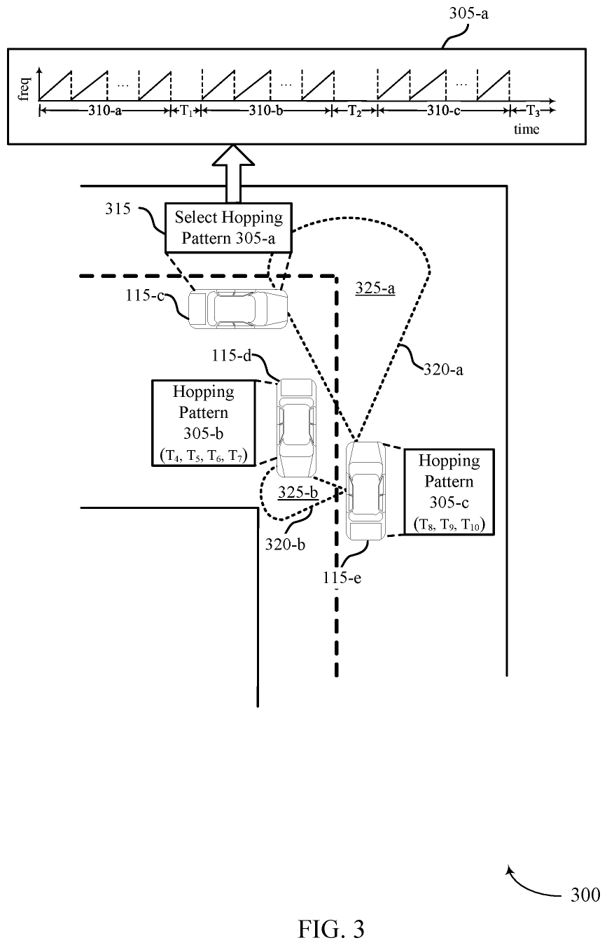

In some cases, UEs 115 in wireless communications system 200 may use hopping patterns that may be periodic and associated with an interfering UE 115 (e.g., a UE ID). The victim UE 115-a may process a time series of detections to identify hopping patterns, which, in turn identify the interfering UE 115-b. Each UE 115 may have a different time when a transmission frame 215 starts with respect to a common time reference (e.g., GPS), which may be referred to as a transmission frame start delay, and an introduced phase, which may linearly increase across chirps. Thus, the interference 225 may appear at a victim UE 115, such as UE 115-a, as a ghost target with an artificial range, velocity, or both whose value depend both on the actual range and velocity of the interferer but also on the introduced transmission frame start delay, phase ramp, or both. In some cases, the radar components at the UEs' 115 radars may employ a “hopping pattern” for their frame start delay, phase ramp, or both, which is described in further detail with respect to FIG. 3. If UEs 115 select hopping patterns (e.g., randomly or otherwise), the impact of an interfering UE 115 to a victim UE 115 may be detection of ghost targets whose range, velocity, or both change unrealistically fast between successive frames. The association and tracking filter of the victim UE 115 may discard the ghost target.

However, if two UEs 115 in wireless communications system 200 select a same hopping pattern, no ghost target hopping may occur, and the victim UE 115 may declare the ghost target as a valid target. Thus, the UEs 115 may vary the parameters in a same transmission frame 215 between two radar components (e.g., rather than individual parameters for each radar component at the UEs 115). If the possible hopping patterns are limited to ones specified in a codebook (e.g., finite), there may be a non-zero probability that the UEs 115 may select a same hopping pattern. If a hopping pattern is randomly and independently selected by two UEs 115, the difference of the parameters between the hopping patterns may remain relatively constant for a number of successive transmission frames 215 triggering the detection of a ghost track.

In some cases, radar signaling from interfering UEs 115 may utilize hopping patterns that result in the difference of hopping patterns between any pairs of radars at UEs 115 that varies sufficiently between two successive transmission frames 215. Sufficient variation across transmission frames of the difference of hopping patterns between a pair of radar components may occur if selection of the hopping patterns is centralized (e.g., performed by a base station). However, in no network coverage conditions (e.g., mode 2 sidelink), a central entity may not be available. Without the presence of a central entity, coordination may be achieved (e.g., via mode-2 sidelink), but with a relatively high signaling or radio-resource cost. Similarly, for radar densities below a threshold, random and independent hopping pattern selection by each UE 115 may be sufficient to reduce mutual interference between pairs of radar components. Thus, relatively few pairs of radars may be aligned with respect to their hopping pattern, where aligned may refer to the hopping patterns having differences that may not vary sufficiently for an association or tracking filter to create a track for resulting ghost target properties (e.g., range, velocity, or both).

In some examples, for application of a hopping pattern scheme without centralized assistance, UEs 115 with aligned (e.g., hopping pattern differences vary minimally) variation hopping patterns may identify themselves (e.g., via a sidelink message), and may perform interference coordination to reduce or avoid interfering with each other. However, a radar component (e.g., FMCW radar receiver) may not be able to determine which radar signals are reflections from an object of signaling from the radar component or a direct incoming radar signal from an interfering radar component (e.g., due to common FMCW configurations). A UE 115, such as UE 115-a, may identify an interfering UE 115, such as UE 115-b, by processing a time series of consecutive transmission frame 215 detections and applying pattern identification, with the pattern itself associated with a radar component or UE ID (e.g., according to a defined or preconfigured manner).

In some cases, UE 115-a may receive a set of radar signals from UE 115-b according to resource diagram 220. UE 115-a may receive the set of radar signals in a set of transmission frame 215, such as transmission frame 215-a and transmission frame 215-b. At 230, UE 115-a may detect a hopping pattern from the set of radar signals during the transmission frames 215. For example, UE 115-a may measure one or more parameters from received chirps, such as time gap or inactivity time between transmission frames, to detect a hopping pattern, which is described in further detail with respect to FIG. 3. UE 115-a and UE 115-b may establish a unicast connection 235 for exchanging one or more sidelink messages based on UE 115-a detecting a hopping pattern from UE 115-b, UE 115-b detecting a hopping pattern from UE 115-a, or both. In some cases, UE 115-a may transmit a sidelink message, such as an interference coordination message 240, for interference coordination between UE 115-a and UE 115-b.

A UE 115 may not perform interference level reduction (e.g., TDM or FDM coordination) until after a hopping pattern is detected and the message exchange has taken place. In some cases, the interference coordination message 240 may use waveform coordination to reduce or avoid generation of ghost targets (e.g., and not masking of actual targets) if the UEs 115 use a same waveform. In some other cases, the interference coordination message 240 may use waveform coordination to reduce or avoid generation of ghost targets and masking of actual targets if the UEs 115 use a different waveform. UE 115-a and UE 115-b may transmit using a same FMCW waveform.

FIG. 3 illustrates an example of a wireless communications system 300 that supports hopping pattern utilization for multi-radar coexistence in accordance with aspects of the present disclosure. In some examples, the wireless communications system 300 may implement aspects of the wireless communications systems 100 or wireless communications system 200. For example, UEs 115 operating in the wireless communications system 300, such as UEs 115 as described with reference to FIGS. 1 and 2, may detect a hopping pattern 305 and perform interference coordination for radar signaling via a sidelink message. The wireless communications system 300 may include one or more vehicles (e.g., a UE 115-c, a UE 115-d, and a UE 115-e) that may travel in various directions or lanes of a roadway. UE 115-c, UE 115-d and 115-e may measure one or more parameters from received chirps, such as time between transmission frames, T, to detect a hopping pattern 305.

In some cases, a UE 115 (e.g., UE 115-c, UE 115-d, and UE 115-e) may follow a hopping pattern scheme as described with reference to FIG. 2. The UE 115 may be a vehicle UE that includes one or more radar components that may be mounted on the UE 115. The UE 115 may support cellular V2X (C-V2X) communications, such as sidelink communications. Each radar component may employ a hopping pattern for varying a frame start time (e.g., delay), frame phase ramp, or both across transmission frames 305. In some examples, the duration of a transmission frame 305 may be fixed, or may vary according to a defined schedule for a UE 115. In some examples, a hopping pattern 305 across the one or more transmission frames 310 may be of a finite duration (e.g., the hopping pattern 305 may last for a set number of consecutive transmission frames 310) and may loop after the duration expires (e.g., periodic pattern). A hopping pattern 305 may be spread across any number of transmission frames 310, and may repeat for each set of radar signal transmissions.

For example, at 315, UE 115-c may select a hopping pattern 305-a for transmitting radar signaling. The hopping pattern 305-a may include gaps between each transmission frame 310, which may vary in duration. For example, after transmission frame 310-a, there may be a gap T₁ prior to transmission frame 310-b. After transmission frame 310-b, there may be a gap T₂ prior to transmission frame 310-c. After transmission frame 310-c, there may be a gap T₃. The transmission frames 310 and corresponding gaps may make up a hopping pattern 305. That is, transmission frame 310-a, transmission frame 310-b, transmission frame 310-c as well as gap T₁, T₂, and T₃, make up hopping pattern 305-a. In some cases, hopping pattern 305-a may repeat across another set of transmission frames 310 according to a periodicity (e.g., of three transmission frames 310). The hopping pattern periodicity may be different among radars, although a maximum period may be defined (e.g., via V2X signaling or otherwise configured or defined).

In some cases, a UE 115 may select a hopping pattern 305 prior to transmitting one or more radar signals. For example, UE 115-c may select hopping pattern 305-a at 315, which may have gaps T₁, T₂, and T₃ between transmission frame 310-a, transmission frame 310-b, and transmission frame 310-c, respectively. UE 115-d may select hopping pattern 305-b, which may have gaps T₄, Tₛ, T₆, and T₇ between a set of transmission frames 310 (e.g., 4 transmission frames 310). UE 115-e may select hopping pattern 305-c, which may have gaps T₈, T₉, and T₁₀ between a set of transmission frames 310. The UEs 115 may select a hopping pattern 305 randomly and independent of other UEs 115 or external factors. The hopping pattern values may be arbitrary (e.g., up to UE implementation) or may be constrained (e.g., within some limits, within a finite set of values that may be defined or provided real time by the network, or both).

In some examples, UE 115-c, UE 115-d, or both may transmit one or more sets of radar signals. A UE 115 may transmit radar signaling 320 within a FOV 325 of the UE 115, as described with reference to FIG. 2. For example, UE 115-e may transmit radar signaling 320-a according to FOV 325-a and radar signaling 320-b according to FOV 325-b, each from a respective radar component of UE 115-e. The radar signals from UE 115-c and UE 115-d may interfere with radar signals from UE 115-e. That is, UE 115-c and UE 115-d may move into FOV 325-a, FOV 325-b, or both, and radar signaling 320 from UE 115-c, UE 115-d, or both may interfere (e.g., be transmitted according to a same time or frequency, or other parameters associated with FMCW radar, with radar signaling 320-a and radar signaling 320-b. Thus, UE 115-e may be referred to as a victim UE 115-e, while UE 115-c, UE 115-d, or both may be referred to as aggressor or interferer UEs 115. In some cases, a victim UE 115, such as UE 115-e, may process a series of target detections from a number of successive transmission frames 310. These detection may or may not include ghost targets, which may appear hopping or inconsistent over range, velocity, or both. For ghost targets generated by interferer UEs 115 with a similar hopping pattern 305 as a victim UE 115, the hopping pattern 305 may not be discarded by an association filter.

In some cases, if each UE 115 selects a hopping pattern 305, a victim UE 115 may identify a pattern, or patterns, from a series of received or otherwise detected radar signals, such as according to which detected targets hop in range, speed, or both across transmission frames 310. As each hopping pattern 305 may be associated with a single UE 115, interfering UEs 115 may be effectively identified, and a victim UE 115 may initiate a V2X sidelink communication (e.g., mode 2) with the interfering UEs 115. For example, UE 115-c may select hopping pattern 305-a at 315, UE 115-d may select hopping pattern 305-b, and UE 115-e may select hopping pattern 305-c. UE 115-e may detect one or more radar signals from UE 115-c, and may identify UE 115-c based on identifying hopping pattern 305-a. Additionally or alternatively, UE 115-e may detect one or more radar signals from UE 115-d, and may identify UE 115-d based on identifying hopping pattern 305-b. UE 115-e may establish or otherwise initiate a sidelink connection with UE 115-c, UE 115-d, or both, such as to perform interference mitigation.

The sidelink communication between UEs 115 may adjust interfering radar transmissions so that the interference among them is eliminated or reduced. For example, UE 115-c, UE 115-d, UE 115-e, or a combination may employ a TDMA scheme, an FDMA scheme, or both to adjust a transmit power, adjust a transmit beam directivity, or the like, to reduce interference. Each UE 115 may communicate the use of such a scheme or parameter adjustment to the interfering UEs 115. In some examples, if there are multiple UEs 115 with radar components in the wireless communications system 300, such as UE 115-, UE 115-d, and UE 115-e, each may follow a unique hopping pattern 305. Each patterns may have a duration, which may include one or more transmission frames 310 (e.g., a same duration or different durations). For example, UE 115-c may select hopping pattern 305-a and UE 115-e may select hopping pattern 305-c, each with a duration of 3 transmission frames 310, while UE 115-d may select hopping pattern 305-b with a duration of 4 transmission frames 310. In some cases, the hopping patterns 305 may repeat indefinitely.

In some cases, the numbers for a gap between transmission frames 310 that may define a hopping pattern 305 according to FIG. 3, such as T₁, T₂, T₃, T₄, T₅, T₆, T₇, T₈, T₉, and T₁₀, may be for illustration purpose. The values may correspond to an applicable range of values for the start of a transmission frame 310, a transmission frame phase ramp, or both. In some examples, UE 115-e, which may be a victim UE 115, may observe a number of targets in each transmission frame 310, with one or more targets appearing to hop (e.g., skip values) in range, speed, or both. By observing a number of transmission frames 310, such as transmission frame 310-a through transmission frame 310-c, UE 115-e may detect a persisting hopping pattern 305 for interfering UEs 115, such as hopping pattern 305-a, hopping pattern 305-b, or both. For example, UE 115-e may detect variation in one or more gaps between transmission frames 310, such as T₁, T₂, and T₃ for hopping pattern 305-a or T₄, T₅, T₆, and T₇ for hopping pattern 305-b. UE 115-e may determine the detected hopping pattern 305 is associated with a UE 115, such as UE 115-c for hopping pattern 305-a or UE 115-d for hopping pattern 305-b.

In some examples, UE 115-e may establish a link with UE 115-c, UE 115-d, or both to perform interference coordination for radar transmissions. UE 115-e may observe ghost target attributes in successive transmission frames 310 and may identify one or more hopping patterns 305 present in the detections. UE 115-a may observe multiple transmission frames 310 for a reliable pattern detection. If the hopping pattern 305 duration is defined globally (e.g., pre-configured for all radar components), the pattern detection may become relatively easier as a victim UE 115 may not infer the hopping pattern duration or period. It may be possible for a hopping pattern 305 for a ghost target to not fall within a detection range of the victim UE 115 for some transmission frames (e.g., range and velocity). That is, there may be one or more transmission frames 310 where ghost frames from an interferer UE 115 may not be visible to the victim UE 115. For these transmission frames 310, the detected hopping pattern value may be set to a null value or not applicable value.

At this stage, the victim UE 115, such as UE 115-e, may have identified the interferer hopping pattern 305, but not the interferer identity. Once the victim UE 115 has identified the hopping pattern 305, the victim UE 115 may transmit a V2X signal. For example, UE 115-e may transmit a broadcast or groupcast signal (e.g., option-1, connectionless, distance-based negative acknowledgement (NACK) signaling, or the like). In some cases, the transmission may indicate the detected pattern (e.g., T₁, T₂, and T₃ for hopping pattern 305-a or T₄, T₅, T₆, and T₇ for hopping pattern 305-b) to UE 115-c, UE 115-d, or both (e.g., UEs 115 within range of UE 115-e).

An interferer UE 115 that receives the transmission (e.g., a sidelink message) and identifies the indicated pattern as its own may initiate a unicast connection with the victim UE 115, which may effectively be identifying the UE 115 as the interferer. For example, UE 115-c may receive a sidelink message from UE 115-e indicating hopping pattern 305-a. UE 115-c may identify itself as an interferer to UE 115-e based on the hopping pattern 305 UE 115-c transmits matching the selected hopping pattern at 315. UE 115-c may initiate a unicast transmission with UE 115-e, which may effectively identify UE 115-c as an interferer. UE 115-e and UE 115-c may jointly coordinate their radar transmissions to avoid or reduce interference. In some cases, the victim UE 115 may not achieve accurate detection of the interferer hopping pattern 305. For example, instead of hopping pattern 305-a, such as T₁, T₂, and T₃, UE 115-e may detect T₁, N/A, and T₃. A UE 115 that receives this pattern indication may compare the detected hopping pattern 305 to its own selected hopping pattern 305. If the hopping pattern is within a threshold, the UE 115 may assume that the indicated pattern 305 corresponds to its own. For example, the UE 115 may compute a correlation, or inner product of the indicated hopping pattern 305 and a selected, own hopping pattern 305 and compare the computation with a threshold. If there are null values (e.g., N/A values) in the hopping pattern 305, the UE 115 may treat them as numerical zeros. A value above a threshold may mean the detected pattern corresponds to a UE 115. In some cases, the threshold may be defined or otherwise configured at the UEs 115 (e.g., preconfigured).

In some cases, the victim UE 115 may indicate its own hopping pattern 305 in the sidelink message. For example, UE 115-e may indicate hopping pattern 305-c, such as T₈, T₉, and T₁₀, in a sidelink message to UE 115-c and UE 115-d. The hopping pattern 305 from the victim UE 115 may serve as additional criterion for a UE 115 receiving the hopping pattern 305 to infer that the UE 115 may be causing the interference. In some examples, interfering UEs 115 may use a similar hopping pattern 305 as a victim UE 115. An additional criterion for a receiving UE 115 to identify itself as the interferer may be if a correlation between the victim UE hopping pattern 305 and a UEs 115 own pattern exceeds a threshold, which may be the same or different than a threshold the victim UE 115 uses to calculate a correlation.

In some examples, a receiving UE 115, such as UE 115-c and UE 115-d, may perform hopping pattern detection. The interference may be mutual, such that if UE 115-e experiences interference from UE 115-c, UE 115-c may also experience interference from UE 115-e. An additional criterion for a UE 115 receiving the sidelink signaling to infer that the UE 115 may be causing the interference is based on the correlation between a hopping pattern 305 of a victim UE 115 (e.g., as indicated in the victim UE radar signal) with the detected interfering hopping pattern 305 at the receiving UE 115. In some cases, the position of the radar components or UEs 115 (e.g., as indicated by a zone-ID in sidelink control information (SCI)) may be used as another criterion for identification of the interferer UE 115. If the zone IDs of two UEs 115 or radar components are relatively far away (e.g., according to a distance measurement), they may not interfere with each other even if they use a same or similar hopping pattern 305.

In some cases, a UE 115 may select a hopping pattern 305 based on a codebook. For example, the hopping pattern 305 employed by UE 115-c, UE 115-d, and UE 115-e may each be extracted from a codebook, based on a UE ID. When a victim UE 115 identifies a hopping pattern 305, the victim UE 115 may extract the UE ID from the codebook and may directly initiate a connection with the interfering UE 115. In some examples, the codebook may be of unlimited size. Each UE ID may be uniquely mapped to a single pattern from a system-wide codebook. For example, the UEs 115 may use a formula (e.g., mathematical transform) to compute a unique hopping pattern 305 from the UE ID. The victim UE 115 may identify the pattern and may apply an inverse transform to identify the UE ID. The victim UE 115 may directly establish a unicast sidelink connection with the UE 115 belonging to the UE ID to coordinate transmissions.

In some other examples, the codebook may be a limited size. For example, a limited number of hoping patterns 305 may be available, such as N hopping patterns 305, resulting in multiple UE IDs employing a same hopping pattern 305. That is, a k-th pattern may be applied for all UE IDs with a value of x, for which mod(x, N)=k. With a relatively large N, the probability of two nearby radar components or UEs 115 selecting a same hopping pattern 305 may be relatively small. The victim UE 115 may identify a hopping pattern 305 and may send a groupcast message with a group destination ID that corresponds to UE IDs that utilize the hopping pattern 305, which may be referred to as groupcast option-2. The group UE ID of a hopping pattern 305 may be specified in the codebook. One or more UEs 115 receiving the message and belonging to the destination group ID, and therefore employing the detected hopping pattern 305, may respond to coordinate transmissions with the victim UE 115.

In some examples, the hopping pattern 305 for each UE 115 may be generated by an encoding operation, where each UE ID may have a unique hopping pattern 305. A UE 115 may input a bit-representation of the UE ID to an encoder. The UE 115 may then map the encoder output to a hopping pattern 305 according to a defined or otherwise configured (e.g., a preconfigured) mapping. The encoder may be defined or otherwise configured. For example, each element of a hopping pattern sequence may be selected out of M values (e.g., may be finite). The encoder output (e.g., a codeword) may be a binary and may include L*log₂ M bits. Each log₂ M bits correspond to an element of the hopping pattern 305 and may be mapped to one of the M values, resulting in a hopping pattern of period L. In some cases, the victim UE 115 may identify a hopping pattern 305 and may apply the hopping pattern 305 to the decoder to extract a UE ID. The victim UE 115 may then establish a unicast connection with the UE 115 with that UE ID.

The UE 115 using an encoding operation may employ codes that may be robust to noise, as well as erasures. An erasure may occur when a ghost target of a transmission frame 310 of a hopping pattern 305 falls outside the victim UEs 115 detection range, which may result in an N/A or null reading. In addition to the UE ID, other parameters may be included as information in the encoding operation (radar specifics as orientation, TX power, etc.). The UE 115 may update a hopping pattern 305 each time the information changes.

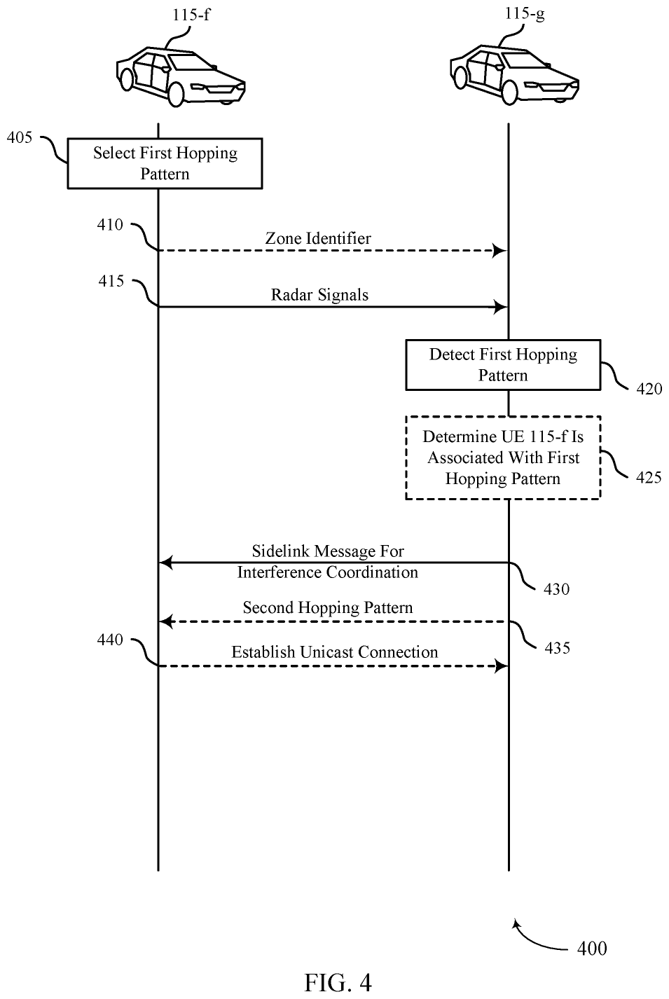

FIG. 4 illustrates an example of a process flow 400 that supports hopping pattern utilization for multi-radar coexistence in accordance with aspects of the present disclosure. In some examples, process flow 400 may implement aspects of wireless communications system 100, wireless communications system 200, and wireless communication system 300. The process flow 400 may illustrate an example of a UE 115-f and UE 115-g, which may be examples of UEs 115 as described with reference to FIG. 1. In some examples, UE 115-g may detect a hopping pattern from a set of radar signals from UE 115-f and may perform interference coordination with UE 115-f. Alternative examples of the following may be implemented, where some processes are performed in a different order than described or are not performed. In some cases, processes may include additional features not mentioned below, or further processes may be added.

In some examples, UE 115-f may be referred to as an interferer UE 115, while UE 115-g may be referred to as a victim UE 115. However, the interference may be mutual, such that UE 115-f and UE 115-g both produce radar signaling that interfere. In some cases, each UE 115 may include one or more radar components for detecting targets.

At 405, a UE 115-f may select a first hopping pattern for transmitting radar signaling. The first hopping pattern may indicate the identity of UE 115-f and be associated with a hopping pattern periodicity. In some cases, UE 115-f may randomly select the first hopping pattern from a set of hopping patterns available for radar signaling by UE 115-f. In some cases, UE 115-f may select the first hopping pattern from a set of hopping patterns configured for radar signaling by UE 115-f, such as from a codebook of hopping patterns.

In some examples, UE 115-f may select the first hopping pattern from a codebook based on a UE ID for UE 115-f. The first hopping pattern may uniquely map to the UE ID. The UE ID may include a UE group ID for the first hopping pattern. That is, each UE 115 using the first hopping pattern may have the UE group ID. Further, the codebook may include a hopping pattern list including the first hopping pattern, multiple hopping patterns for radar signaling, a system-wide codebook, or the like.

UE 115-f may generate the first hopping pattern based on performing an encoding operation on a binary alphabet representation of one or more parameter values for UE 115-f, where the first hopping pattern is unique to a UE ID for UE 115-f. Further, the one or more parameters may include the UE ID, orientation of the radar signaling, a transmit power, or a combination thereof.

In some cases, at 410, UE 115-f may transmit SCI indicating a zone ID of UE 115-f. UE 115-g may receive the zone ID and determine the position of UE 115-f relative to itself based on the zone identified. Further, transmitting the sidelink message may be based on the position of UE 115-f.

At 415, UE 115-f may transmit a set of radar signals in a set of transmission frames according to the first hopping pattern and the hopping pattern periodicity

UE 115-g may receive radar signals from UE 115-f and, at 420, detect a hopping pattern from the set of radar signals based on receiving the set of radar signals in the set of transmission frames. For example, UE 115-g may detect a variation in a frame start time of the set of radar signals in the set of transmission frames or a variation in frame phase ramp of the set of radar signals in the set of transmission frames, or both, where the hopping pattern may be a finite duration.

In some cases, at 425, UE 115-g may determine that UE 115-f is associated with the detected hopping pattern based on a periodicity of the hopping pattern. UE 115-g may apply a decoder to the detected hopping pattern to obtain the UE ID. Further, UE 115-g may determine a UE ID associated with the hopping pattern based on a codebook for hopping patterns.

At 430, UE 115-g may transmit, to UE 115-f, a sidelink message for interference coordination between UE 115-g and UE 115-f based on detecting the hopping pattern. The sidelink message may include an indication of the detected hopping pattern, an additional hopping pattern for UE 115-g (e.g., that UE 115-g selected), or both. In some cases, UE 115-g may transmit the sidelink message to multiple UEs 115 in a broadcast or groupcast transmission, the UEs 115 including UE 115-f.

In some cases, at 435, UE 115-f may receive, from UE 115-g, a sidelink message indicating a second hopping pattern, a third hopping pattern for UE 115-g, or both. UE 115-f may then determine at least one of the second hopping pattern or the third hopping pattern satisfies a threshold, configured at UE 115-g and for the first hopping pattern. The threshold may be a first value for the second hopping pattern and a second value for the third hopping pattern. The values may be the same or may be different. In some cases, a network may configure the thresholds at the UEs 115, the thresholds may be defined at the UEs 115, or the like. UE 115-f may determine a correlation product of the second hopping pattern and the first hopping pattern and may compare the correlation product with at least one of the thresholds.

At 440, UE 115-f may establish a unicast connection with UE 115-g based on the transmitted set of radar signals, the unicast connection for performing interference coordination between UE 115-f and UE 115-g. Further, UE 115-f may perform interference coordination with UE 115-g based on determining that the second hopping pattern or the third hopping pattern satisfy the threshold.

In some cases, UE 115-f may receive a second set of radar signals in a second set of transmission frames. UE 115-f may detect a second hopping pattern associated with the second set of radar signals based at least in part on receiving the second set of radar signals in the second set of transmission frames. Upon detecting a second hopping pattern, UE 115-f may transmit, to UE 115-g, a sidelink message for interference coordination based on detecting the second hopping pattern. That is, both an interfering UE 115 and a victim UE 115 may perform hopping pattern detection and interference coordination (e.g., due to mutual interference between the two). Further, UE 115-f may determine a correlation between the second hopping pattern and the first hopping pattern, where transmitting the sidelink message may be based on the correlation satisfying a threshold.

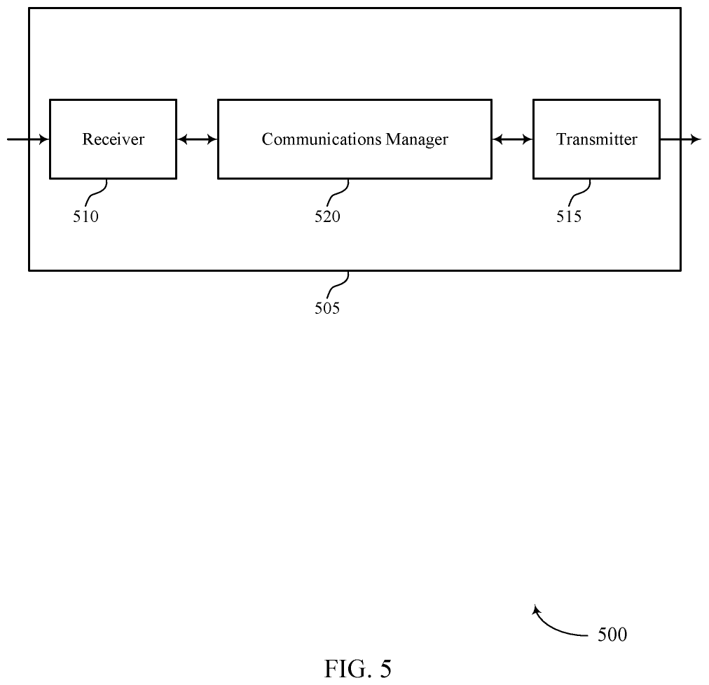

FIG. 5 shows a block diagram 500 of a device 505 that supports hopping pattern utilization for multi-radar coexistence in accordance with aspects of the present disclosure. The device 505 may be an example of aspects of a vehicle UE as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to hopping pattern utilization for multi-radar coexistence). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to hopping pattern utilization for multi-radar coexistence). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of hopping pattern utilization for multi-radar coexistence as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signaling processor (DSP), an application-specific integrated circuit (ASIC), a field-programmable gate-array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 520 may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communication at a first UE in accordance with examples as disclosed herein. For example, the communications manager 520 may be configured as or otherwise support a means for receiving a set of radar signals in a set of transmission frames. The communications manager 520 may be configured as or otherwise support a means for detecting a hopping pattern associated with the set of radar signals based on receiving the set of radar signals in the set of transmission frames. The communications manager 520 may be configured as or otherwise support a means for transmitting, to a second UE, a sidelink message for interference coordination between the first UE and the second UE based on detecting the hopping pattern.

Additionally or alternatively, the communications manager 520 may support wireless communication at a vehicle UE in accordance with examples as disclosed herein. For example, the communications manager 520 may be configured as or otherwise support a means for selecting a first hopping pattern for transmitting radar signaling by the vehicle UE, the first hopping pattern indicative of an identity of the vehicle UE and associated with a hopping pattern periodicity. The communications manager 520 may be configured as or otherwise support a means for transmitting a set of radar signals in a set of transmission frames according to the first hopping pattern and the hopping pattern periodicity.

By including or configuring the communications manager 520 in accordance with examples as described herein, the device 505 (e.g., a processor controlling or otherwise coupled to the receiver 510, the transmitter 515, the communications manager 520, or a combination thereof) may support techniques for a UE 115 to detect a hopping pattern of a set of radar signals from another UE 115 and perform interference coordination with the other UE 115, which may cause reduced processing, reduced power consumption, more efficient utilization of communication resources, and the like.

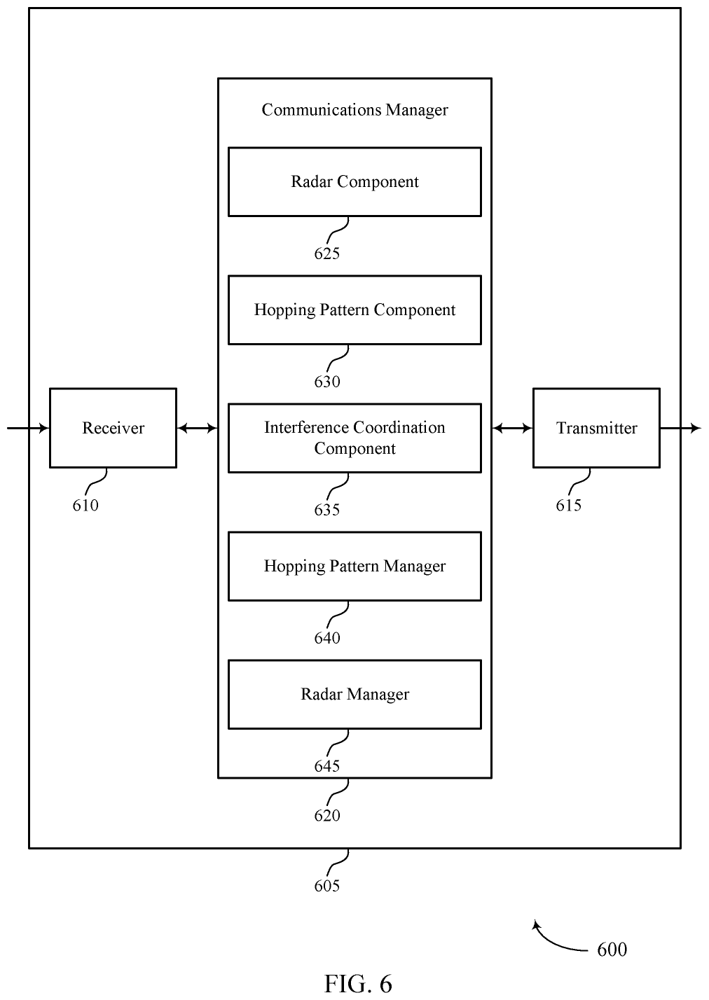

FIG. 6 shows a block diagram 600 of a device 605 that supports hopping pattern utilization for multi-radar coexistence in accordance with aspects of the present disclosure. The device 605 may be an example of aspects of a device 505 or a vehicle UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to hopping pattern utilization for multi-radar coexistence). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to hopping pattern utilization for multi-radar coexistence). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of hopping pattern utilization for multi-radar coexistence as described herein. For example, the communications manager 620 may include a radar component 625, a hopping pattern component 630, an interference coordination component 635, a hopping pattern manager 640, a radar manager 645, or any combination thereof. The communications manager 620 may be an example of aspects of a communications manager 520 as described herein. In some examples, the communications manager 620, or various components thereof, may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communication at a first UE in accordance with examples as disclosed herein. The radar component 625 may be configured as or otherwise support a means for receiving a set of radar signals in a set of transmission frames. The hopping pattern component 630 may be configured as or otherwise support a means for detecting a hopping pattern associated with the set of radar signals based on receiving the set of radar signals in the set of transmission frames. The interference coordination component 635 may be configured as or otherwise support a means for transmitting, to a second UE, a sidelink message for interference coordination between the first UE and the second UE based on detecting the hopping pattern.

Additionally or alternatively, the communications manager 620 may support wireless communication at a vehicle UE in accordance with examples as disclosed herein. The hopping pattern manager 640 may be configured as or otherwise support a means for selecting a first hopping pattern for transmitting radar signaling by the vehicle UE, the first hopping pattern indicative of an identity of the vehicle UE and associated with a hopping pattern periodicity. The radar manager 645 may be configured as or otherwise support a means for transmitting a set of radar signals in a set of transmission frames according to the first hopping pattern and the hopping pattern periodicity.

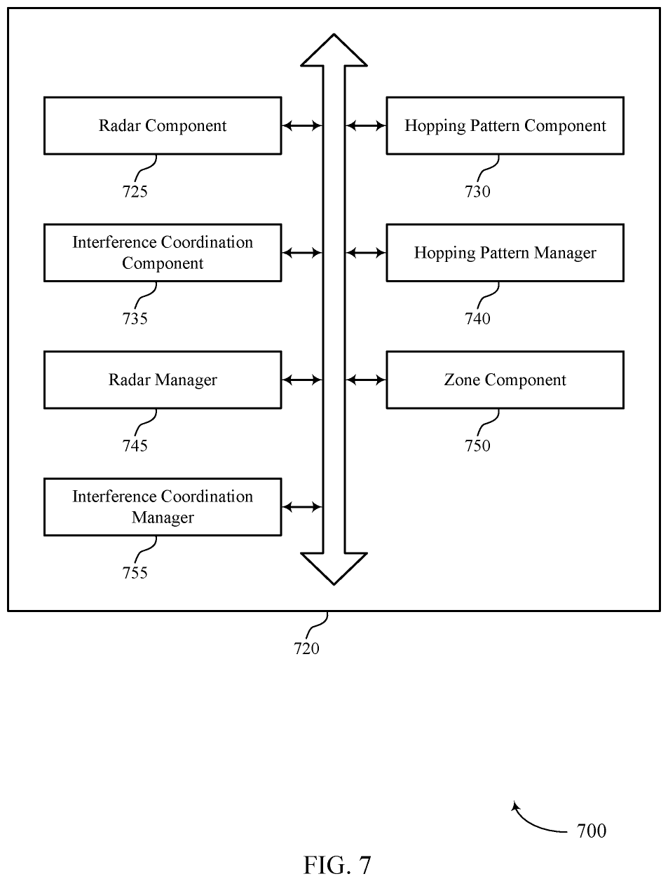

FIG. 7 shows a block diagram 700 of a communications manager 720 that supports hopping pattern utilization for multi-radar coexistence in accordance with aspects of the present disclosure. The communications manager 720 may be an example of aspects of a communications manager 520, a communications manager 620, or both, as described herein. The communications manager 720, or various components thereof, may be an example of means for performing various aspects of hopping pattern utilization for multi-radar coexistence as described herein. For example, the communications manager 720 may include a radar component 725, a hopping pattern component 730, an interference coordination component 735, a hopping pattern manager 740, a radar manager 745, a zone component 750, an interference coordination manager 755, or any combination thereof. Each of these components may communicate, directly or indirectly, with one another (e.g., via one or more buses).

The communications manager 720 may support wireless communication at a first UE in accordance with examples as disclosed herein. The radar component 725 may be configured as or otherwise support a means for receiving a set of radar signals in a set of transmission frames. The hopping pattern component 730 may be configured as or otherwise support a means for detecting a hopping pattern associated with the set of radar signals based on receiving the set of radar signals in the set of transmission frames. The interference coordination component 735 may be configured as or otherwise support a means for transmitting, to a second UE, a sidelink message for interference coordination between the first UE and the second UE based on detecting the hopping pattern.

In some examples, to support detecting the hopping pattern, the hopping pattern component 730 may be configured as or otherwise support a means for detecting a variation in a frame start time of the set of radar signals in the set of transmission frames or a variation in frame phase ramp of the set of radar signals in the set of transmission frames, or both, where the hopping pattern is associated with a finite duration.

In some examples, the hopping pattern component 730 may be configured as or otherwise support a means for determining that the second UE is associated with the detected hopping pattern based on a periodicity of the hopping pattern.

In some examples, to support determining that the second UE is associated with the detected hopping pattern, the hopping pattern component 730 may be configured as or otherwise support a means for determining a UE ID associated with the hopping pattern based on a codebook for hopping patterns.

In some examples, the hopping pattern component 730 may be configured as or otherwise support a means for applying a decoder to the detected hopping pattern to obtain the UE ID.

In some examples, to support transmitting the sidelink message, the interference coordination component 735 may be configured as or otherwise support a means for transmitting the sidelink message to a set of multiple UEs in a broadcast or groupcast transmission, the set of multiple UEs including the second UE.

In some examples, the zone component 750 may be configured as or otherwise support a means for receiving sidelink control information indicating a zone ID of the second UE. In some examples, the zone component 750 may be configured as or otherwise support a means for determining a position of the second UE relative to the first UE based on the zone ID, where transmitting the sidelink message is based on the position of the second UE.

In some examples, the sidelink message includes an indication of the detected hopping pattern, an additional hopping pattern associated with the first UE, or both.

Additionally or alternatively, the communications manager 720 may support wireless communication at a vehicle UE in accordance with examples as disclosed herein. The hopping pattern manager 740 may be configured as or otherwise support a means for selecting a first hopping pattern for transmitting radar signaling by the vehicle UE, the first hopping pattern indicative of an identity of the vehicle UE and associated with a hopping pattern periodicity. The radar manager 745 may be configured as or otherwise support a means for transmitting a set of radar signals in a set of transmission frames according to the first hopping pattern and the hopping pattern periodicity.

In some examples, to support selecting the first hopping pattern, the hopping pattern manager 740 may be configured as or otherwise support a means for randomly selecting the first hopping pattern from a set of hopping patterns available for radar signaling by the vehicle UE.

In some examples, to support selecting the first hopping pattern, the hopping pattern manager 740 may be configured as or otherwise support a means for selecting the first hopping pattern from a set of hopping patterns configured for radar signaling by the vehicle UE.

In some examples, to support selecting the first hopping pattern, the hopping pattern manager 740 may be configured as or otherwise support a means for selecting the first hopping pattern from a codebook based on a UE ID corresponding to the vehicle UE, the codebook including a set of multiple hopping patterns for radar signaling.

In some examples, the first hopping pattern is uniquely mapped to the UE ID. In some examples, the codebook includes a system-wide codebook.

In some examples, the codebook includes a hopping pattern list including the first hopping pattern. In some examples, the UE ID includes a UE group ID corresponding to the first hopping pattern.

In some examples, to support selecting the first hopping pattern, the hopping pattern manager 740 may be configured as or otherwise support a means for generating the first hopping pattern based on performing an encoding operation on a binary alphabet representation of one or more parameter values corresponding to the vehicle UE, where the first hopping pattern is unique to a UE ID corresponding to the vehicle UE.

In some examples, the one or more parameters include the UE ID, orientation of the radar signaling, a transmit power, or a combination thereof.

In some examples, the hopping pattern manager 740 may be configured as or otherwise support a means for receiving, from a second UE, a sidelink message indicating a second hopping pattern, a third hopping pattern corresponding to the second UE, or both. In some examples, the hopping pattern manager 740 may be configured as or otherwise support a means for determining at least one of the second hopping pattern or the third hopping pattern satisfies a threshold associated with the first hopping pattern. In some examples, the interference coordination manager 755 may be configured as or otherwise support a means for performing interference coordination with the second UE based on determining that the at least one of the second hopping pattern or the third hopping pattern satisfying the threshold.

In some examples, the threshold is configured at the vehicle UE.

In some examples, the threshold includes a first value for the second hopping pattern and a second value for the third hopping pattern.

In some examples, to support determining that the second hopping pattern satisfies the threshold, the hopping pattern manager 740 may be configured as or otherwise support a means for determining a correlation product of the second hopping pattern and the first hopping pattern. In some examples, to support determining that the second hopping pattern satisfies the threshold, the hopping pattern manager 740 may be configured as or otherwise support a means for comparing the correlation product with the threshold.

In some examples, the radar manager 745 may be configured as or otherwise support a means for establishing a unicast connection with an additional UE based on the transmitted set of radar signals, the unicast connection for performing interference coordination between the vehicle UE and the additional UE.

In some examples, the radar manager 745 may be configured as or otherwise support a means for receiving a second set of radar signals in a second set of transmission frames. In some examples, the hopping pattern manager 740 may be configured as or otherwise support a means for detecting a second hopping pattern associated with the second set of radar signals based on receiving the second set of radar signals in the second set of transmission frames. In some examples, the interference coordination manager 755 may be configured as or otherwise support a means for transmitting, to a second UE, a sidelink message for interference coordination between the vehicle UE and the second UE based on detecting the second hopping pattern.

In some examples, the hopping pattern manager 740 may be configured as or otherwise support a means for determining a correlation between the second hopping pattern and the first hopping pattern, where transmitting the sidelink message is based on the correlation satisfying a threshold.

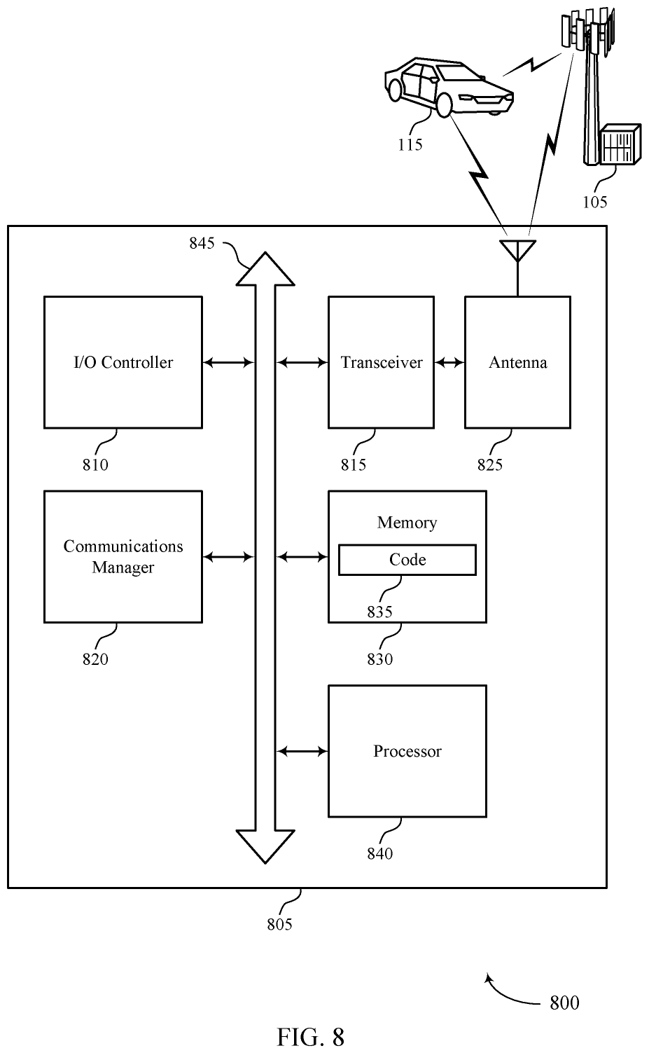

FIG. 8 shows a diagram of a system 800 including a device 805 that supports hopping pattern utilization for multi-radar coexistence in accordance with aspects of the present disclosure. The device 805 may be an example of or include the components of a device 505, a device 605, or a vehicle UE as described herein. The device 805 may include components for bi-directional voice and data communications including components for transmitting and receiving communications, such as a communications manager 820, an I/O controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random-access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting hopping pattern utilization for multi-radar coexistence). For example, the device 805 or a component of the device 805 may include a processor 840 and memory 830 coupled to the processor 840, the processor 840 and memory 830 configured to perform various functions described herein.

The communications manager 820 may support wireless communication at a first UE in accordance with examples as disclosed herein. For example, the communications manager 820 may be configured as or otherwise support a means for receiving a set of radar signals in a set of transmission frames. The communications manager 820 may be configured as or otherwise support a means for detecting a hopping pattern associated with the set of radar signals based on receiving the set of radar signals in the set of transmission frames. The communications manager 820 may be configured as or otherwise support a means for transmitting, to a second UE, a sidelink message for interference coordination between the first UE and the second UE based on detecting the hopping pattern.

Additionally or alternatively, the communications manager 820 may support wireless communication at a vehicle UE in accordance with examples as disclosed herein. For example, the communications manager 820 may be configured as or otherwise support a means for selecting a first hopping pattern for transmitting radar signaling by the vehicle UE, the first hopping pattern indicative of an identity of the vehicle UE and associated with a hopping pattern periodicity. The communications manager 820 may be configured as or otherwise support a means for transmitting a set of radar signals in a set of transmission frames according to the first hopping pattern and the hopping pattern periodicity.

By including or configuring the communications manager 820 in accordance with examples as described herein, the device 805 may support techniques for a UE 115 to detect a hopping pattern of a set of radar signals from another UE 115 and perform interference coordination with the other UE 115, which may cause improved communication reliability, reduced latency, improved user experience related to reduced processing, reduced power consumption, more efficient utilization of communication resources, improved coordination between devices, longer battery life, improved utilization of processing capability, and the like.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of hopping pattern utilization for multi-radar coexistence as described herein, or the processor 840 and the memory 830 may be otherwise configured to perform or support such operations.

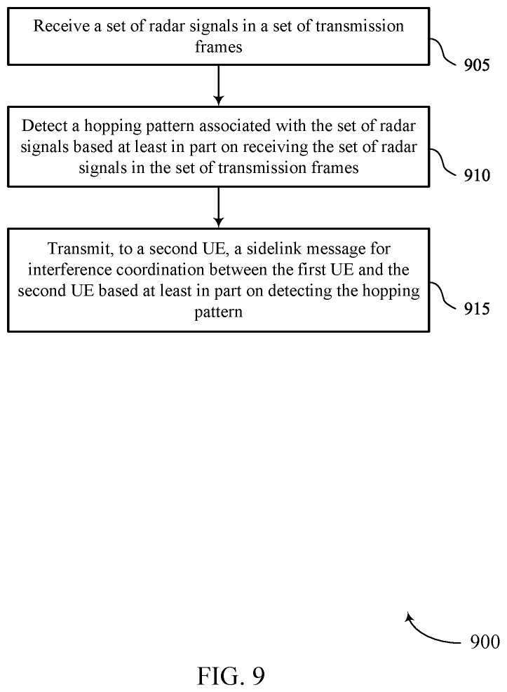

FIG. 9 shows a flowchart illustrating a method 900 that supports hopping pattern utilization for multi-radar coexistence in accordance with aspects of the present disclosure. The operations of the method 900 may be implemented by a vehicle UE or its components as described herein. For example, the operations of the method 900 may be performed by a vehicle UE as described with reference to FIGS. 1 through 8. In some examples, a vehicle UE may execute a set of instructions to control the functional elements of the vehicle UE to perform the described functions. Additionally or alternatively, the vehicle UE may perform aspects of the described functions using special-purpose hardware.

At 905, the method may include receiving a set of radar signals in a set of transmission frames. The operations of 905 may be performed in accordance with examples as disclosed herein. In some examples, aspects of the operations of 905 may be performed by a radar component 725 as described with reference to FIG. 7.

At 910, the method may include detecting a hopping pattern associated with the set of radar signals based on receiving the set of radar signals in the set of transmission frames. The operations of 910 may be performed in accordance with examples as disclosed herein. In some examples, aspects of the operations of 910 may be performed by a hopping pattern component 730 as described with reference to FIG. 7.

At 915, the method may include transmitting, to a second UE, a sidelink message for interference coordination between the first UE and the second UE based on detecting the hopping pattern. The operations of 915 may be performed in accordance with examples as disclosed herein. In some examples, aspects of the operations of 915 may be performed by an interference coordination component 735 as described with reference to FIG. 7.

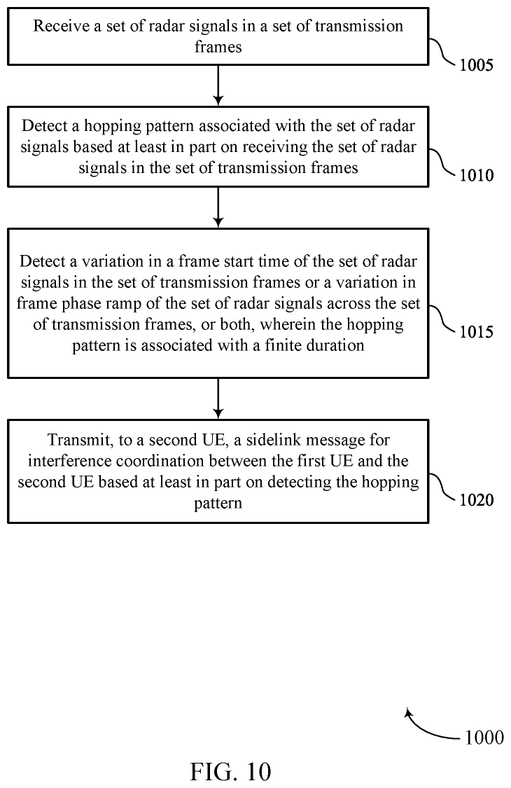

FIG. 10 shows a flowchart illustrating a method 1000 that supports hopping pattern utilization for multi-radar coexistence in accordance with aspects of the present disclosure. The operations of the method 1000 may be implemented by a vehicle UE or its components as described herein. For example, the operations of the method 1000 may be performed by a vehicle UE as described with reference to FIGS. 1 through 8. In some examples, a vehicle UE may execute a set of instructions to control the functional elements of the vehicle UE to perform the described functions. Additionally or alternatively, the vehicle UE may perform aspects of the described functions using special-purpose hardware.

At 1005, the method may include receiving a set of radar signals in a set of transmission frames. The operations of 1005 may be performed in accordance with examples as disclosed herein. In some examples, aspects of the operations of 1005 may be performed by a radar component 725 as described with reference to FIG. 7.

At 1010, the method may include detecting a hopping pattern associated with the set of radar signals based on receiving the set of radar signals in the set of transmission frames. The operations of 1010 may be performed in accordance with examples as disclosed herein. In some examples, aspects of the operations of 1010 may be performed by a hopping pattern component 730 as described with reference to FIG. 7.

At 1015, the method may include detecting a variation in a frame start time of the set of radar signals in the set of transmission frames or a variation in frame phase ramp of the set of radar signals in the set of transmission frames, or both, where the hopping pattern is associated with a finite duration. The operations of 1015 may be performed in accordance with examples as disclosed herein. In some examples, aspects of the operations of 1015 may be performed by a hopping pattern component 730 as described with reference to FIG. 7.

At 1020, the method may include transmitting, to a second UE, a sidelink message for interference coordination between the first UE and the second UE based on detecting the hopping pattern. The operations of 1020 may be performed in accordance with examples as disclosed herein. In some examples, aspects of the operations of 1020 may be performed by an interference coordination component 735 as described with reference to FIG. 7.

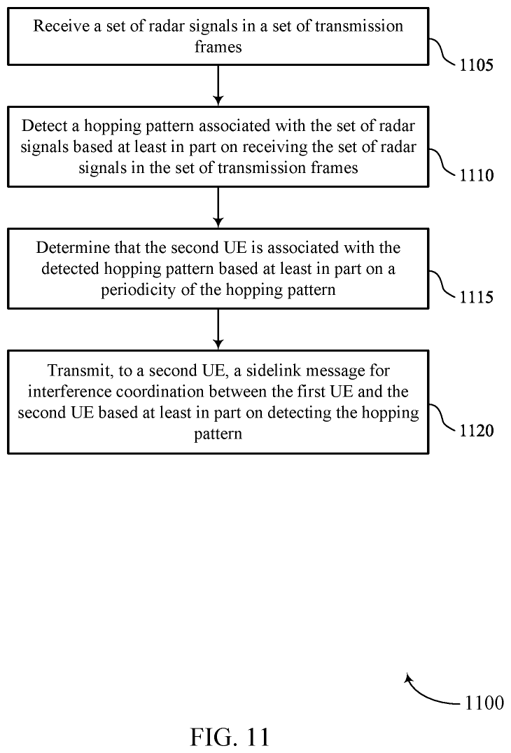

FIG. 11 shows a flowchart illustrating a method 1100 that supports hopping pattern utilization for multi-radar coexistence in accordance with aspects of the present disclosure. The operations of the method 1100 may be implemented by a vehicle UE or its components as described herein. For example, the operations of the method 1100 may be performed by a vehicle UE as described with reference to FIGS. 1 through 8. In some examples, a vehicle UE may execute a set of instructions to control the functional elements of the vehicle UE to perform the described functions. Additionally or alternatively, the vehicle UE may perform aspects of the described functions using special-purpose hardware.

At 1105, the method may include receiving a set of radar signals in a set of transmission frames. The operations of 1105 may be performed in accordance with examples as disclosed herein. In some examples, aspects of the operations of 1105 may be performed by a radar component 725 as described with reference to FIG. 7.

At 1110, the method may include detecting a hopping pattern associated with the set of radar signals based on receiving the set of radar signals in the set of transmission frames. The operations of 1110 may be performed in accordance with examples as disclosed herein. In some examples, aspects of the operations of 1110 may be performed by a hopping pattern component 730 as described with reference to FIG. 7.

At 1115, the method may include determining that the second UE is associated with the detected hopping pattern based on a periodicity of the hopping pattern. The operations of 1115 may be performed in accordance with examples as disclosed herein. In some examples, aspects of the operations of 1115 may be performed by a hopping pattern component 730 as described with reference to FIG. 7.

At 1120, the method may include transmitting, to a second UE, a sidelink message for interference coordination between the first UE and the second UE based on detecting the hopping pattern. The operations of 1120 may be performed in accordance with examples as disclosed herein. In some examples, aspects of the operations of 1120 may be performed by an interference coordination component 735 as described with reference to FIG. 7.

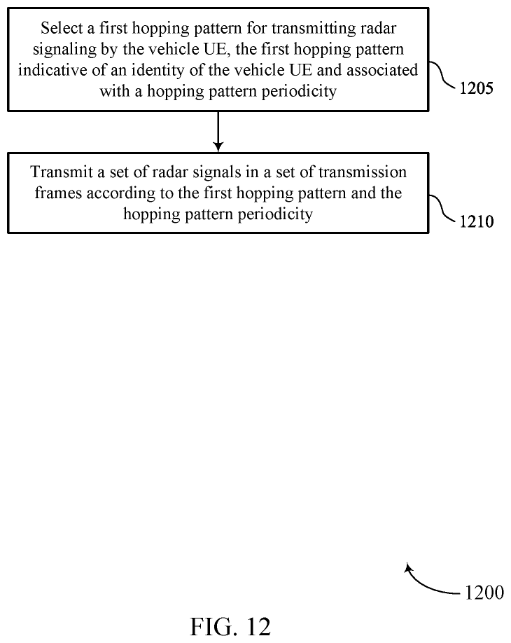

FIG. 12 shows a flowchart illustrating a method 1200 that supports hopping pattern utilization for multi-radar coexistence in accordance with aspects of the present disclosure. The operations of the method 1200 may be implemented by a vehicle UE or its components as described herein. For example, the operations of the method 1200 may be performed by a vehicle UE as described with reference to FIGS. 1 through 8. In some examples, a vehicle UE may execute a set of instructions to control the functional elements of the vehicle UE to perform the described functions. Additionally or alternatively, the vehicle UE may perform aspects of the described functions using special-purpose hardware.

At 1205, the method may include selecting a first hopping pattern for transmitting radar signaling by the vehicle UE, the first hopping pattern indicative of an identity of the vehicle UE and associated with a hopping pattern periodicity. The operations of 1205 may be performed in accordance with examples as disclosed herein. In some examples, aspects of the operations of 1205 may be performed by a hopping pattern manager 740 as described with reference to FIG. 7.

At 1210, the method may include transmitting a set of radar signals in a set of transmission frames according to the first hopping pattern and the hopping pattern periodicity. The operations of 1210 may be performed in accordance with examples as disclosed herein. In some examples, aspects of the operations of 1210 may be performed by a radar manager 745 as described with reference to FIG. 7.

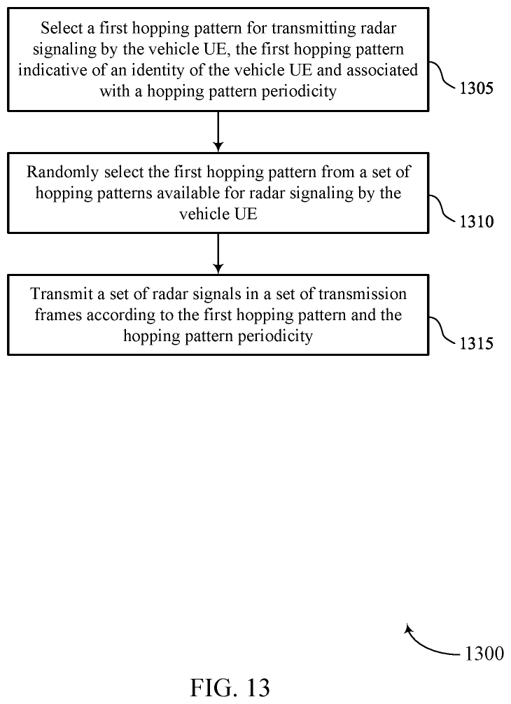

FIG. 13 shows a flowchart illustrating a method 1300 that supports hopping pattern utilization for multi-radar coexistence in accordance with aspects of the present disclosure. The operations of the method 1300 may be implemented by a vehicle UE or its components as described herein. For example, the operations of the method 1300 may be performed by a vehicle UE as described with reference to FIGS. 1 through 8. In some examples, a vehicle UE may execute a set of instructions to control the functional elements of the vehicle UE to perform the described functions. Additionally or alternatively, the vehicle UE may perform aspects of the described functions using special-purpose hardware.

At 1305, the method may include selecting a first hopping pattern for transmitting radar signaling by the vehicle UE, the first hopping pattern indicative of an identity of the vehicle UE and associated with a hopping pattern periodicity. The operations of 1305 may be performed in accordance with examples as disclosed herein. In some examples, aspects of the operations of 1305 may be performed by a hopping pattern manager 740 as described with reference to FIG. 7.

At 1310, the method may include randomly selecting the first hopping pattern from a set of hopping patterns available for radar signaling by the vehicle UE. The operations of 1310 may be performed in accordance with examples as disclosed herein. In some examples, aspects of the operations of 1310 may be performed by a hopping pattern manager 740 as described with reference to FIG. 7.

At 1315, the method may include transmitting a set of radar signals in a set of transmission frames according to the first hopping pattern and the hopping pattern periodicity. The operations of 1315 may be performed in accordance with examples as disclosed herein. In some examples, aspects of the operations of 1315 may be performed by a radar manager 745 as described with reference to FIG. 7.

The following provides an overview of aspects of the present disclosure:

Aspect 1: A method for wireless communication at a first UE, comprising: receiving a set of radar signals in a set of transmission frames; detecting a hopping pattern associated with the set of radar signals based at least in part on receiving the set of radar signals in the set of transmission frames; and transmitting, to a second UE, a sidelink message for interference coordination between the first UE and the second UE based at least in part on detecting the hopping pattern.

Aspect 2: The method of aspect 1 wherein detecting the hopping pattern comprises: detecting a variation in a frame start time of the set of radar signals in the set of transmission frames or a variation in frame phase ramp of the set of radar signals in the set of transmission frames, or both, wherein the hopping pattern is associated with a finite duration.

Aspect 3: The method of any of aspects 1 through 2, further comprising: determining that the second UE is associated with the detected hopping pattern based at least in part on a periodicity of the hopping pattern.

Aspect 4: The method of aspect 3, wherein determining that the second UE is associated with the detected hopping pattern comprises: determining a UE identifier associated with the hopping pattern based at least in part on a codebook for hopping patterns.

Aspect 5: The method of aspect 4, further comprising: applying a decoder to the detected hopping pattern to obtain the UE identifier.

Aspect 6: The method of any of aspects 1 through 5, wherein transmitting the sidelink message comprises: transmitting the sidelink message to a plurality of UEs in a broadcast or groupcast transmission, the plurality of UEs comprising the second UE.

Aspect 7: The method of any of aspects 1 through 6, further comprising: receiving sidelink control information indicating a zone identifier of the second UE; and determining a position of the second UE relative to the first UE based at least in part on the zone identifier, wherein transmitting the sidelink message is based at least in part on the position of the second UE.

Aspect 8: The method of any of aspects 1 through 7, wherein the sidelink message comprises an indication of the detected hopping pattern, an additional hopping pattern associated with the first UE, or both.

Aspect 9: A method for wireless communication at a vehicle UE, comprising: selecting a first hopping pattern for transmitting radar signaling by the vehicle UE, the first hopping pattern indicative of an identity of the vehicle UE and associated with a hopping pattern periodicity; and transmitting a set of radar signals in a set of transmission frames according to the first hopping pattern and the hopping pattern periodicity.

Aspect 10: The method of aspect 9, wherein selecting the first hopping pattern comprises: randomly selecting the first hopping pattern from a set of hopping patterns available for radar signaling by the vehicle UE.

Aspect 11: The method of aspect 9, wherein selecting the first hopping pattern comprises: selecting the first hopping pattern from a set of hopping patterns configured for radar signaling by the vehicle UE.

Aspect 12: The method of aspect 9, wherein selecting the first hopping pattern comprises: selecting the first hopping pattern from a codebook based at least in part on a UE identifier corresponding to the vehicle UE, the codebook comprising a plurality of hopping patterns for radar signaling.

Aspect 13: The method of aspect 12, wherein the first hopping pattern is uniquely mapped to the UE identifier, and the codebook comprises a system-wide codebook.

Aspect 14: The method of any of aspects 12 through 13, wherein the codebook comprises a hopping pattern list comprising the first hopping pattern, and the UE identifier comprises a UE group identifier corresponding to the first hopping pattern.

Aspect 15: The method of aspect 9, wherein selecting the first hopping pattern comprises: generating the first hopping pattern based at least in part on performing an encoding operation on a binary alphabet representation of one or more parameter values corresponding to the vehicle UE, wherein the first hopping pattern is unique to a UE identifier corresponding to the vehicle UE.

Aspect 16: The method of aspect 15, wherein the one or more parameters comprise the UE identifier, orientation of the radar signaling, a transmit power, or a combination thereof.

Aspect 17: The method of any of aspects 9 through 16, further comprising: receiving, from a second UE, a sidelink message indicating a second hopping pattern, a third hopping pattern corresponding to the second UE, or both; determining at least one of the second hopping pattern or the third hopping pattern satisfies a threshold associated with the first hopping pattern; and performing interference coordination with the second UE based at least in part on determining that the at least one of the second hopping pattern or the third hopping pattern satisfying the threshold.

Aspect 18: The method of aspect 17, wherein the threshold is configured at the vehicle UE.

Aspect 19: The method of any of aspects 17 through 18, wherein the threshold comprises a first value for the second hopping pattern and a second value for the third hopping pattern.

Aspect 20: The method of any of aspects 17 through 19, wherein determining that the second hopping pattern satisfies the threshold comprises: determining a correlation product of the second hopping pattern and the first hopping pattern; and comparing the correlation product with the threshold.

Aspect 21: The method of any of aspects 9 through 20, further comprising: establishing a unicast connection with an additional UE based at least in part on the transmitted set of radar signals, the unicast connection for performing interference coordination between the vehicle UE and the additional UE.

Aspect 22: The method of any of aspects 9 through 21, further comprising: receiving a second set of radar signals in a second set of transmission frames; detecting a second hopping pattern associated with the second set of radar signals based at least in part on receiving the second set of radar signals in the second set of transmission frames; and transmitting, to a second UE, a sidelink message for interference coordination between the vehicle UE and the second UE based at least in part on detecting the second hopping pattern.

Aspect 23: The method of aspect 22, further comprising: determining a correlation between the second hopping pattern and the first hopping pattern, wherein transmitting the sidelink message is based at least in part on the correlation satisfying a threshold.

Aspect 24: An apparatus for wireless communication at a first UE, comprising a processor; memory coupled with the processor; and instructions stored in the memory and executable by the processor to cause the apparatus to perform a method of any of aspects 1 through 8.

Aspect 25: An apparatus for wireless communication at a first UE, comprising at least one means for performing a method of any of aspects 1 through 8.

Aspect 26: A non-transitory computer-readable medium storing code for wireless communication at a first UE, the code comprising instructions executable by a processor to perform a method of any of aspects 1 through 8.

Aspect 27: An apparatus for wireless communication at a vehicle UE, comprising a processor; memory coupled with the processor; and instructions stored in the memory and executable by the processor to cause the apparatus to perform a method of any of aspects 9 through 23.

Aspect 28: An apparatus for wireless communication at a vehicle UE, comprising at least one means for performing a method of any of aspects 9 through 23.

Aspect 29: A non-transitory computer-readable medium storing code for wireless communication at a vehicle UE, the code comprising instructions executable by a processor to perform a method of any of aspects 9 through 23.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a first user equipment (UE), comprising:
a processor;
memory coupled with the processor; and
instructions stored in the memory and executable by the processor to cause the apparatus to:
receive a set of radar signals in a set of transmission frames;
detect a hopping pattern associated with the set of radar signals based at least in part on receiving the set of radar signals in the set of transmission frames; and
transmit, to a second UE, a sidelink message for interference coordination between the first UE and the second UE based at least in part on detecting the hopping pattern.

2. The apparatus of claim 1, wherein the instructions to detect the hopping pattern are executable by the processor to cause the apparatus to:
detect a variation in a frame start time of the set of radar signals in the set of transmission frames or a variation in frame phase ramp of the set of radar signals in the set of transmission frames, or both, wherein the hopping pattern is associated with a finite duration.

3. The apparatus of claim 1, wherein the instructions are further executable by the processor to cause the apparatus to:
determine that the second UE is associated with the detected hopping pattern based at least in part on a periodicity of the hopping pattern.

4. The apparatus of claim 3, wherein the instructions to determine that the second UE is associated with the detected hopping pattern are executable by the processor to cause the apparatus to:
determine a UE identifier associated with the hopping pattern based at least in part on a codebook for hopping patterns.

5. The apparatus of claim 4, wherein the instructions are further executable by the processor to cause the apparatus to:
apply a decoder to the detected hopping pattern to obtain the UE identifier.

6. The apparatus of claim 1, wherein the instructions to transmit the sidelink message are executable by the processor to cause the apparatus to:
transmit the sidelink message to a plurality of UEs in a broadcast or groupcast transmission, the plurality of UEs comprising the second UE.

7. The apparatus of claim 1, wherein the instructions are further executable by the processor to cause the apparatus to:
receive sidelink control information indicating a zone identifier of the second UE; and
determine a position of the second UE relative to the first UE based at least in part on the zone identifier, wherein transmitting the sidelink message is based at least in part on the position of the second UE.

8. The apparatus of claim 1, wherein the sidelink message comprises an indication of the detected hopping pattern, an additional hopping pattern associated with the first UE, or both.

9. An apparatus for wireless communication at a vehicle user equipment (UE), comprising:
a processor;
memory coupled with the processor; and
instructions stored in the memory and executable by the processor to cause the apparatus to:
select a first hopping pattern for transmitting radar signaling by the vehicle UE, the first hopping pattern indicative of an identity of the vehicle UE and associated with a hopping pattern periodicity; and
transmit a set of radar signals in a set of transmission frames according to the first hopping pattern and the hopping pattern periodicity.

10. The apparatus of claim 9, wherein the instructions to select the first hopping pattern are executable by the processor to cause the apparatus to:
randomly select the first hopping pattern from a set of hopping patterns available for radar signaling by the vehicle UE.

11. The apparatus of claim 9, wherein the instructions to select the first hopping pattern are executable by the processor to cause the apparatus to:
select the first hopping pattern from a set of hopping patterns configured for radar signaling by the vehicle UE.

12. The apparatus of claim 9, wherein the instructions to select the first hopping pattern are executable by the processor to cause the apparatus to:
select the first hopping pattern from a codebook based at least in part on a UE identifier corresponding to the vehicle UE, the codebook comprising a plurality of hopping patterns for radar signaling.

13. The apparatus of claim 12, wherein:
the first hopping pattern is uniquely mapped to the UE identifier, and
the codebook comprises a system-wide codebook.

14. The apparatus of claim 12, wherein:
the codebook comprises a hopping pattern list comprising the first hopping pattern, and
the UE identifier comprises a UE group identifier corresponding to the first hopping pattern.

15. The apparatus of claim 9, wherein the instructions to select the first hopping pattern are executable by the processor to cause the apparatus to:
generate the first hopping pattern based at least in part on performing an encoding operation on a binary alphabet representation of one or more parameter values corresponding to the vehicle UE, wherein the first hopping pattern is unique to a UE identifier corresponding to the vehicle UE.

16. The apparatus of claim 15, wherein the one or more parameters comprise the UE identifier, orientation of the radar signaling, a transmit power, or a combination thereof.

17. The apparatus of claim 9, wherein the instructions are further executable by the processor to cause the apparatus to:
receive, from a second UE, a sidelink message indicating a second hopping pattern, a third hopping pattern corresponding to the second UE, or both;
determine at least one of the second hopping pattern or the third hopping pattern satisfies a threshold associated with the first hopping pattern; and
perform interference coordination with the second UE based at least in part on determining that the at least one of the second hopping pattern or the third hopping pattern satisfying the threshold.

18. The apparatus of claim 17, wherein the threshold is configured at the vehicle UE.

19. The apparatus of claim 17, wherein the threshold comprises a first value for the second hopping pattern and a second value for the third hopping pattern.

20. The apparatus of claim 17, wherein the instructions to determine that the second hopping pattern satisfies the threshold are executable by the processor to cause the apparatus to:
determine a correlation product of the second hopping pattern and the first hopping pattern; and
compare the correlation product with the threshold.

21. The apparatus of claim 9, wherein the instructions are further executable by the processor to cause the apparatus to:
establish a unicast connection with an additional UE based at least in part on the transmitted set of radar signals, the unicast connection for performing interference coordination between the vehicle UE and the additional UE.

22. The apparatus of claim 9, wherein the instructions are further executable by the processor to cause the apparatus to:
receive a second set of radar signals in a second set of transmission frames;
detect a second hopping pattern associated with the second set of radar signals based at least in part on receiving the second set of radar signals in the second set of transmission frames; and
transmit, to a second UE, a sidelink message for interference coordination between the vehicle UE and the second UE based at least in part on detecting the second hopping pattern.

23. The apparatus of claim 22, wherein the instructions are further executable by the processor to cause the apparatus to:
determine a correlation between the second hopping pattern and the first hopping pattern, wherein transmitting the sidelink message is based at least in part on the correlation satisfying a threshold.

24. A method for wireless communication at a first user equipment (UE), comprising:
receiving a set of radar signals in a set of transmission frames;
detecting a hopping pattern associated with the set of radar signals based at least in part on receiving the set of radar signals in the set of transmission frames; and
transmitting, to a second UE, a sidelink message for interference coordination between the first UE and the second UE based at least in part on detecting the hopping pattern.

25. The method of claim 24 wherein detecting the hopping pattern comprises:
detecting a variation in a frame start time of the set of radar signals in the set of transmission frames or a variation in frame phase ramp of the set of radar signals in the set of transmission frames, or both, wherein the hopping pattern is associated with a finite duration.

26. The method of claim 24, further comprising:
determining that the second UE is associated with the detected hopping pattern based at least in part on a periodicity of the hopping pattern.

27. The method of claim 24, wherein transmitting the sidelink message comprises:
transmitting the sidelink message to a plurality of UEs in a broadcast or groupcast transmission, the plurality of UEs comprising the second UE.

28. The method of claim 24, further comprising:
receiving sidelink control information indicating a zone identifier of the second UE; and
determining a position of the second UE relative to the first UE based at least in part on the zone identifier, wherein transmitting the sidelink message is based at least in part on the position of the second UE.

29. The method of claim 24, wherein the sidelink message comprises an indication of the detected hopping pattern, an additional hopping pattern associated with the first UE, or both.

30. A method for wireless communication at a vehicle user equipment (UE), comprising:
selecting a first hopping pattern for transmitting radar signaling by the vehicle UE, the first hopping pattern indicative of an identity of the vehicle UE and associated with a hopping pattern periodicity; and
transmitting a set of radar signals in a set of transmission frames according to the first hopping pattern and the hopping pattern periodicity.
